(19) United States
(12) Patent Application Publication
(10) Pub. No.: US 2010/0280860 A1
(43) Pub. Date: Nov. 4, 2010

(54) CONTEXTUAL SOCIAL NETWORK BASED ON THE SEMANTIC WEB

(75) Inventors: Alexander Iskold, Livingston, NJ (US); Fraser Kelton, New York, NY (US); Karen Teng, New York, NY (US)

Correspondence Address: GIBBONS P.C., ONE GATEWAY CENTER, NEWARK, NJ, 07102, US

(73) Assignee: Adaptiveblue Inc., Livingston, NJ (US)

(21) Appl. No.: 12/433,681

(22) Filed: Apr. 30, 2009

(51) Int. Cl. G06Q 10/00; G06F 17/40; G06F 15/16; G06F 17/30

(52) U.S. Cl. 705/7; 709/202; 707/E17.055; 707/E17.014

(57) ABSTRACT

A social network built around objects viewed over the Internet. A user interacts with a web page presenting a recognizable object (for example, a book, a restaurant or a stock quote). A plug-in in the user's browser extracts information from the web page, creates an identifier for the object, and records the interaction at a network node for the object and a network node for the user. The plug-in further creates a toolbar that is displayed with the web page, which identifies other viewers who recently viewed the object on the Internet and, in particular, other viewers who have been selected by the user as friends. The user may view a profile for any of the other viewers that provides links to the web page where the selected viewer viewed the object, to other objects viewed by that viewer and to other viewers linked to the viewer.

### FIELD OF THE INVENTION

The present invention relates to social networks that are dynamically formed in relation to objects as they are viewed on the Semantic Web, and more particularly, to social networks that are dynamically formed to link users around commonly-viewed objects, where each commonly-viewed object is semantically identified with a standard identifier when viewed at any of a plurality of web pages where the object is a subject of the web page.

### BACKGROUND OF THE INVENTION

In software, semantic technology encodes meanings separately from data and content files, and separately from application code.

This enables machines as well as people to understand, share and reason with these meanings at execution time. With semantic technologies, adding, changing and implementing new relationships or interconnecting programs in a different way can be just as simple as changing the external model that these programs share.

With traditional information technology, on the other hand, meanings and relationships must be predefined and “hard wired” into data formats and the application program code at design time. This means that when something changes, previously unexchanged information needs to be exchanged, or when two programs need to interoperate in a new way, humans must get involved.

Off-line, the parties must define and communicate between them the knowledge needed to make the change, then recode the data structures and program logic to accommodate it, and then apply these changes to the database and the application. Then, and only then, can they implement the changes.

In contrast to traditional information technologies, semantic technologies are “meaning-centered.” They include tools for:
autorecognition of topics and concepts,
information and meaning extraction, and
categorization.

The Semantic Web is an evolving extension of the World Wide Web, in which the semantics of information and services on the web is defined, making it possible for the web to understand and satisfy the requests of people and machines for using the web content. It derives from World Wide Web Consortium (W3C) director Sir Tim Berners-Lee's vision of the Web as a universal medium for data, information, and knowledge exchange. Toward this end, a variety of formal specifications have been developed for expressing elements of the Semantic Web, including Resource Description Framework (RDF), a variety of data interchange formats (e.g. RDF/XML, N3, Turtle, N-Triples), and notations such as RDF Schema (RDFS) and the Web Ontology Language (OWL), all of which are intended to provide a formal description of concepts, terms, and relationships within a given knowledge domain.

These technologies are combined in order to provide descriptions that supplement or replace the content of Web documents. Thus, content may be manifested as descriptive data stored in Web-accessible databases, or as markup within documents (particularly, in Extensible HTML (XHTML) interspersed with XML, or, more often, purely in XML, with layout/rendering cues stored separately). The machine-readable descriptions enable content managers to add meaning to the content, i.e. to describe the structure of the knowledge we have about that content. In this way, a machine can process knowledge itself, instead of just the text, using processes similar to human deductive reasoning and inference, thereby obtaining more meaningful results and facilitating automated information gathering and research by computers.

People are becoming increasingly interested in using the Internet as a means for connecting with others who share similar interests and/or activities. Social networking websites are being used regularly by millions of people, and it now seems that social networking will be an enduring part of everyday life. Currently, the main types of social networking services are those which contain directories of some categories (such as former classmates), means to connect with friends (usually with self-description pages), and recommender systems linked to trust. Popular methods now combine many of these, with MYSPACE and FACEBOOK being two of the most widely-used social networking sites in North America.

Recently, GOOGLE introduced its FRIEND CONNECT product, which allows publishers of blogs and other personal web sites to add social networking features directly to these sites. However, like other current social networking services, this product suffers from several significant limitations.

For example, the urge to employ current social networking services and other personal web sites to determine what friends and others think may be triggered when a user is looking at a particular object on a particular web page. However, this urge may often go unsatisfied, as the user may find that it is just too cumbersome and involved to break away from the web page that he or she is viewing in order to log in to a social network service or personal web site of interest, or even to open an e-mail or instant messaging (IM) client in order to query friends to obtain to their opinions.

While a particular web site presenting the web page that the user is looking at may provide a local mechanism for users to record their opinions about an object of the web page (for example, AMAZON.COM's “Create your own review” feature), the opinions may only be provided by other users who visit the web page. In other words, the web site hosting the web page is unable to provide the opinions of other users who viewed the object at other web sites, and therefore is unable to provide information about other objects that these other users viewed at the other web sites.

### SUMMARY OF THE INVENTION

The present invention is directed to providing a mechanism for dynamically constructing a social network in the context of an object that is being viewed by a user at a web page, and providing direct access to this social network while the user is viewing the web page. Objects may include many different types of tangible things, for example albums, blogs, books, gadgets (for example, personal computers and MP3 players), recording artists, movies, movie stars, recipes, restaurants, stocks, video games, wines, and the like.

By constructing the social network in the context of an object, the present invention enables the user to be connected to other users who have viewed and presumably share an interest in the object. Broadly, the present invention enables people (users) to be connected around the common things (objects) that they visit at various web sites accessible via the Internet.

The present invention makes extensive use of semantic technologies for constructing the social networks. For example, semantic technologies are used for recognizing and identifying one or more objects that are intended subjects of a web page in a normalized form. As a result, a single object viewed by users at each of various web sites may be identically identified and represented.

In a preferred embodiment, the invention is at least in part embodied in a plug-in component for installation in a conventional web browser application, which is capable of communicating with an associated web-based server and a database management system.

In this preferred embodiment, when the user interacts via the browser with a web page presenting one of a variety of recognizable objects (for example, a book, a movie, an artist, a restaurant or a stock quote), the plug-in extracts information from the web page, creates a descriptor for the object in a normalized, standardized format, and records the interaction both at a network node for the object and at a network node for the user. The information may for example be preferably recorded and retrieved by the database management system.

The plug-in preferably creates a toolbar that is thereafter displayed with the web page, which identifies other viewers of the object who are either friends of the user (in other words, people that the user has identified as social contacts or has otherwise elected to follow). In addition, the toolbar preferably identifies other people who have recently viewed the object at a web page on the Internet. Information about friends and other viewers may preferably be retrieved from the network node for the object and network nodes for each of the friends and other viewers.

In the preferred embodiment, the user may import social contacts from other network sources (for example, FACEBOOK, TWITTER, GMAIL and the like) and identify these imported contacts as friends. Thereafter, if the user visits a web page having an object previously viewed by one or more of these friends, the one or more friends will be identified in the user's toolbar. In addition, the user may expand his or her community of friends by selecting some of the other recent viewers of the object to be added as friends.

The toolbar also preferably includes one or more buttons that may be selected by the user to express an attitude or feeling about the object being viewed. For example, an “I like this” button may be provided to enable the user to indicate that he or she liked the object. Alternatively, or in addition, an “Add My 2¢” button may be provided for the user to more explicitly express an attitude or feeling in words. The attitude or feeling need not be limited to a like for the object. For example, the user may express a dislike for the object, or a thought that is related but not specifically directed to the object.

In addition to the object that the user is presently viewing, the user may explore a great variety of other objects of potential interest that have been viewed by the other viewers identified on the toolbar. For example, the user may click on a toolbar icon for another viewer in order to identify and navigate to a different web page at which the other viewer viewed the object that the user is currently viewing. At his different web page the user will likely be able to obtain additional information of interest about the object.

The user may also click on the other viewer's icon to identify other objects that the other viewer has viewed, and navigate directly to the web pages at which the other user viewed these objects. In this manner, the user is able to discover other objects which may have a significant likelihood of being of interest to the user because they have been viewed by another like-minded viewer. In this manner, the user may recursively discover even more viewers of these other things, and even more objects of interest viewed by these additional viewers.

For example, when the user navigates to a selected web page to view a another object, the plug-in either creates or retrieves a descriptor for this object in a normalized format, and records the interaction (including information identifying the other object, the user and the web page) both at a network node for the other object and at the network node for the user. As a result, the other object may be easily discovered by other viewers who visit any web page presenting the first object viewed by the user, because the user will be identified at that web page as a viewer of both objects. More particularly, viewers who select the user's icon at a web page featuring the first object will be able to identify and navigate to the other object (for example, to the web page on which the other object was viewed by the user.

On the web page on which the other object was viewed by the user, information retrieved both at a network node for the other object and at network nodes for other viewers identified at the network node as having viewed the other object is used to prepare a toolbar identifying the other viewers. The user may click on an icon for one of the other viewers the to identify other objects that the other viewer has viewed, and to navigate to the web pages at which the other user viewed these objects In this manner, the user is able to navigate recursively between things and viewers to expand his or her collection of viewed objects. In addition, the user is able to expand his or her social network by adding one or more of the other viewers to his or her set of friends.

In summary, the present invention provides a method and mechanism for a user to connect with other like-minded people on the basis of things (objects) that this community of people have commonly viewed at various web pages accessible via the Internet. By identifying other viewers who have viewed a common object, and identifying other objects that these other viewers have viewed, the user is able to move recursively between viewers and things to explore and discover a great variety of new objects and new contacts of potential interest. In addition, the user can selectively easily join new social networks formed around new objects of interest.

Semantic technology enables the social networks to be formed and reformed automatically, without requiring users for example to log into particular social networking sites dedicated for this purpose. Rather, semantic technology enables the social networks to be dynamically formed and made available to a user each and every time he or she uses a browser application to view a thing (object) of interest. By practicing of the present invention, users are able over time to explore and find a great variety of different objects of interest, and to identify a great number of potential friends who share like-minded interests.

### BRIEF DESCRIPTION OF THE DRAWINGS

The invention will become more readily apparent from the Detailed Description of the Invention, which proceeds with reference to the drawings, in which:

FIG. 1 illustrates a system architecture in accordance with principles of the present invention;

FIG. 2 presents a schematic diagram illustrating elements of a general-purpose computer used in the system suitable for use in the system architecture of FIG. 1;

FIGS. 3A-3I present flow diagrams illustrating methods of operation in accordance with principles of the present invention;

FIGS. 4A-4R illustrate a first series of web pages presented by a system to a user in accordance with principles of the present invention;

FIGS. 5A-5I illustrate a second series of web pages presented by a system to a user in accordance with principles of the present invention, and

FIGS. 6A-6F illustrate a third series of web pages presented by a system to a user in accordance with principles of the present invention.

### DETAILED DESCRIPTION OF THE INVENTION

The present invention is now more fully described, with reference to several exemplary embodiments. These embodiments are provided to illustrate principles of the present invention, including a best mode for practicing the invention as contemplated by the inventors, and therefore may describe elements that are not essential to practicing the invention or for which equivalents that perform the same function are known in the art. Therefore, the scope of the invention is only limited according to the elements of the claims.

### Overview

The present invention is directed to a system and method for providing a social network in the context of objects viewed by users browsing the Internet. In a preferred embodiment of the present invention, a user interacts with a web page presenting one of a variety of recognizable objects (for example, a book, a restaurant or a stock quote). A plug-in in the user's browser extracts information from the web page, creates a descriptor for the object in a normalized format, and records the interaction at a network node for the object and at a network node for the user. The plug-in further preferably creates a toolbar that is displayed with the web page and identifies other viewers who recently viewed the object on the Internet. By selecting an icon of one of the other viewers, a profile for the other viewer is preferably displayed with links to the web page where that viewer viewed the object, links to other objects viewed by the other viewer and friends of the other viewer. The profile for the other viewer also preferably provides information about objects viewed by the other viewer that were liked by the viewer and information about objects the other viewer has commented on.

Central to the operation of the present invention is a process by which the object is recognized by the application of semantic technologies. Several recognition methods are employed in the preferred embodiment. First, the plug-in determines whether an object identifier has been placed into the coding for the web page in a standardized, recognizable format (for example, a meta-data type format). If no standardized identifier is found, the plug-in next determines whether a URL for the web page is present in a URL cache which cross-references URLs to object identifiers. If not, the plug-in proceeds to perform an analysis of the contents of web page according to particularized rules (“heuristics”) for identifying the object. This latter approach is particularly important for identifying any new object (for example, as may provided by a new web page source). Heuristics may be based, for example, on the identity of the source and on clues provided in the content of the web page. The analysis produces a preliminary object identifier, which is adjusted by using object information in the preliminary object identifier to search semantic databases and other web sources to find possible matches adjust the preliminary object identified according to object information provided by a best one of the possible matches.

### System Architecture

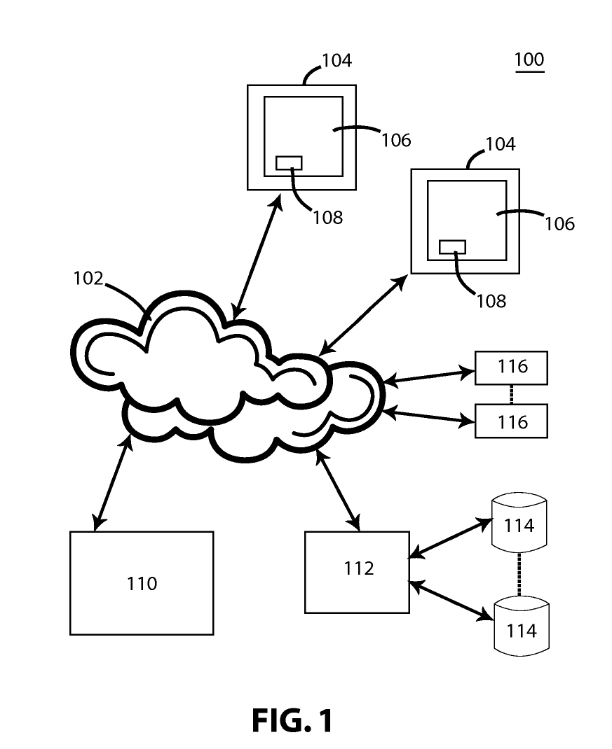

FIG. 1 illustrates an exemplary system architecture 100 on which the present invention may be practiced. In FIG. 1, one or more local area networks (“LANs”) and/or wide area networks (“WAN”) are included in a network 102, such as the Internet, that enables communication between various users, devices, servers, clients, processes, and the like. As shown, clients 104 employ network 102 to communicate, for example, with social network server 110 and other web servers 116, accessible, for example via the Internet.

Each of the clients 104 includes a browser application 106, for example, for accessing web pages hosted by the web servers 116. The browsers 106 each include one or more plug-ins 108 which instruct the browser 106 to interact with the social network server 110 in order to implement the features of the present invention.

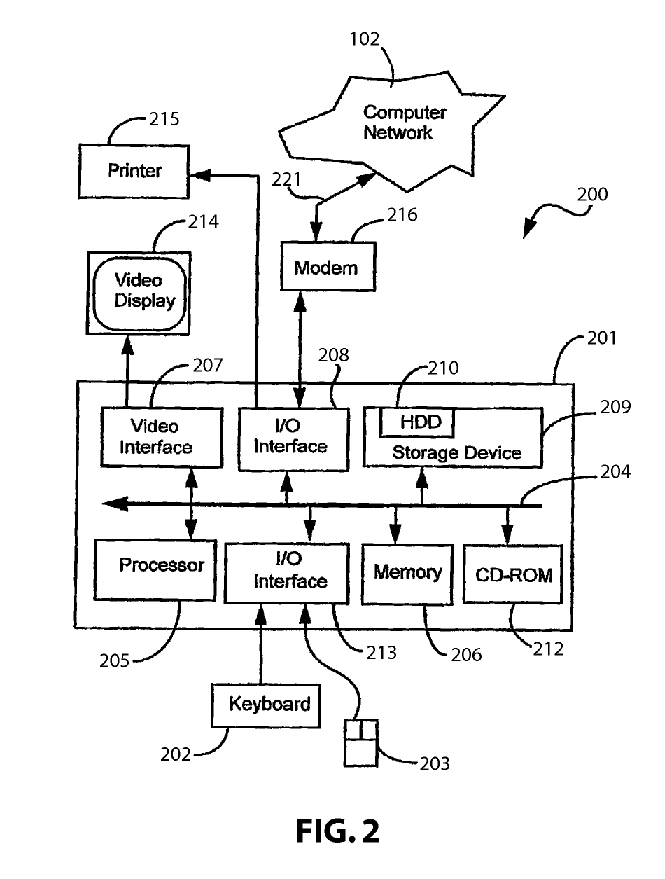

Each of clients 104 and social network server 110 may preferably comprise a general-purpose computer system 200, such as that shown in FIG. 2. The computer system 200 includes a computer module 201, input devices such as a keyboard 202 and mouse 203, output devices including a printer 215 and a display device 214. A modem 216 may be used by the computer module 201 for communicating to and from the network 102 via coaxial cable, fiber or other functional medium 221.

The computer module 201 typically includes at least the one processor unit 205, a memory unit 206 (for example, formed from semiconductor random access memory (RAM) and read only memory (ROM)), input/output (I/O) interfaces including a video interface 207, and an I/O interface 213 for the keyboard 202 and the mouse 203, and an I/O interface 208 for the modem 216. A storage device 209 is provided and may typically include a hard disk drive 210. A magnetic tape drive (not illustrated) may also be included. A CD-ROM or DVD-ROM drive 212 may also be provided as a non-volatile source of data.

The components 205 to 213 of the computer module 201 typically communicate via an interconnected bus 204 Examples of computers on which the described arrangements can be practiced include IBM-PCs and compatibles, APPLE computers, SUN SPARCSTATIONS and other like computer systems. Clients 104 may typically be run on WINDOWS or MAC OS-based operating systems, while social network server 110 is preferably configured as a conventional, LINUX-based web server.

For external data storage, social network server 110 is further able to communicate via the network 102 with database server 112 to create, populate and search databases 114. In the present case, for example, the functions of database server 112 may be preferably provided by AMAZON.COM's SimpleDB web service, or any like service or database management system. Alternatively, the functions fulfilled by the database server 112 and databases 114 may be provided by the social network server 110 and its associated memory devices, and/or by one or more of the clients 104.

### Method of Operation

A user begins the process of accessing the contextual social network according to the present invention by downloading and installing the client browser plug-in by one of a variety of conventional means (for example, from an add-on web site associated with a browser provider).

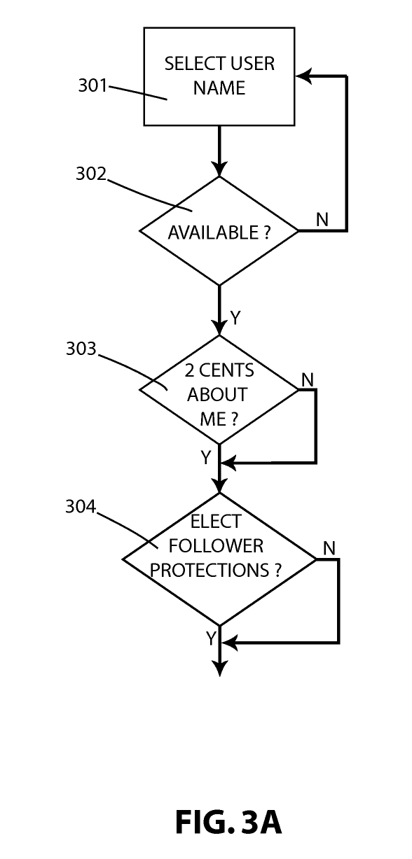

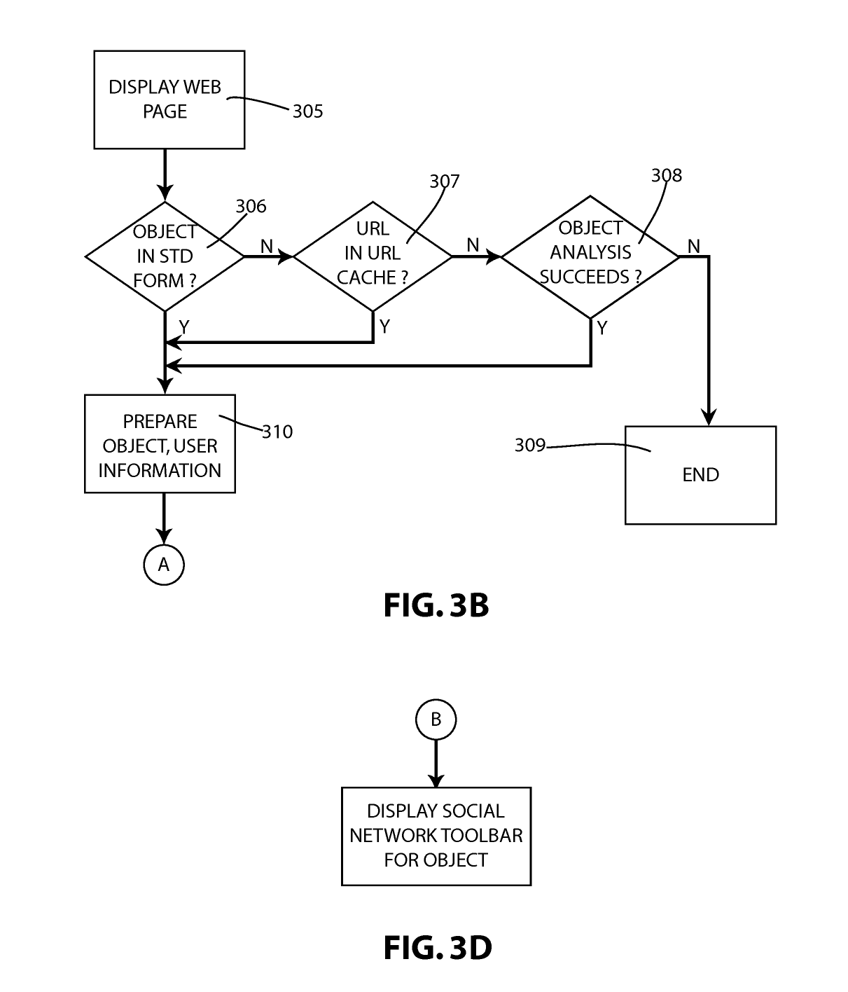

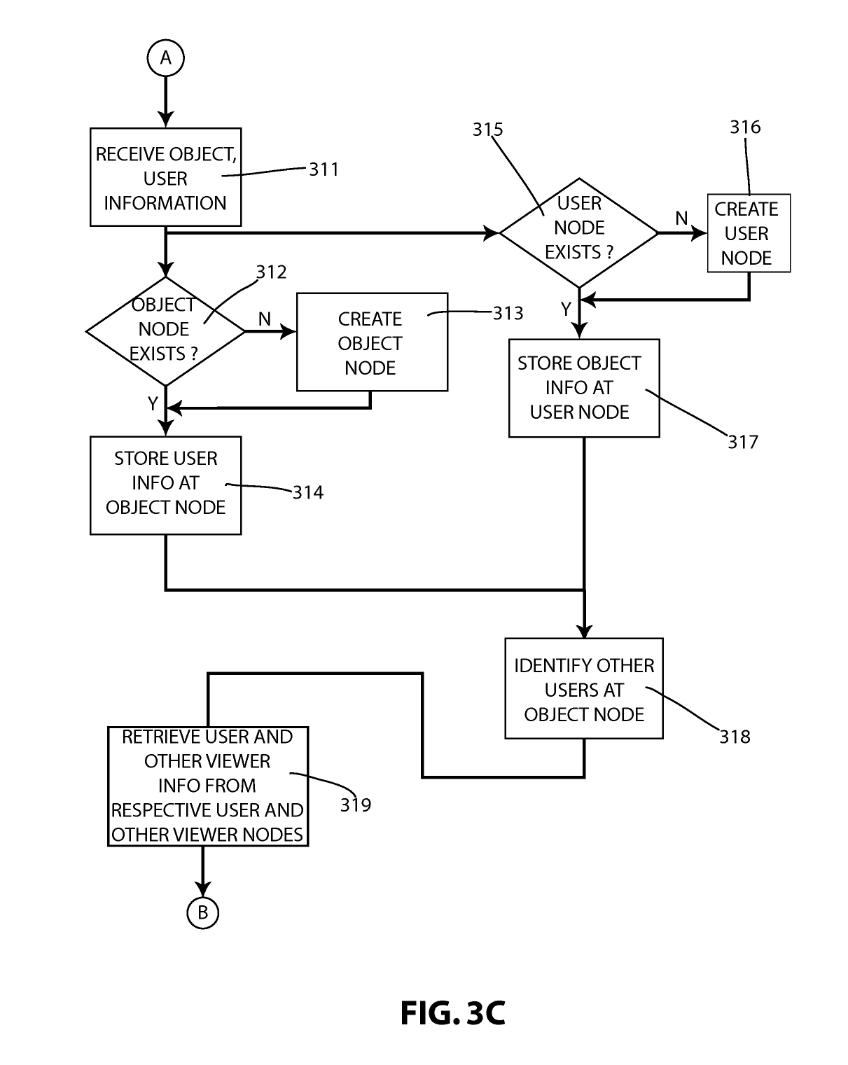

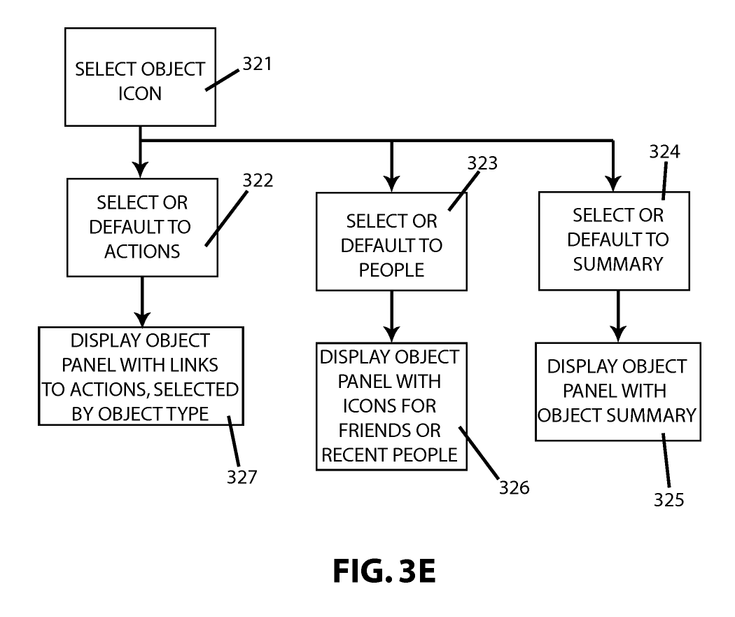

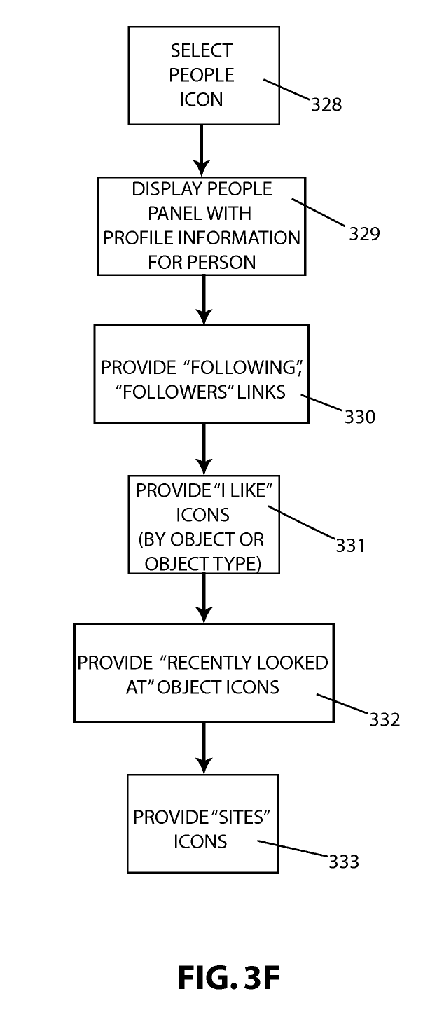

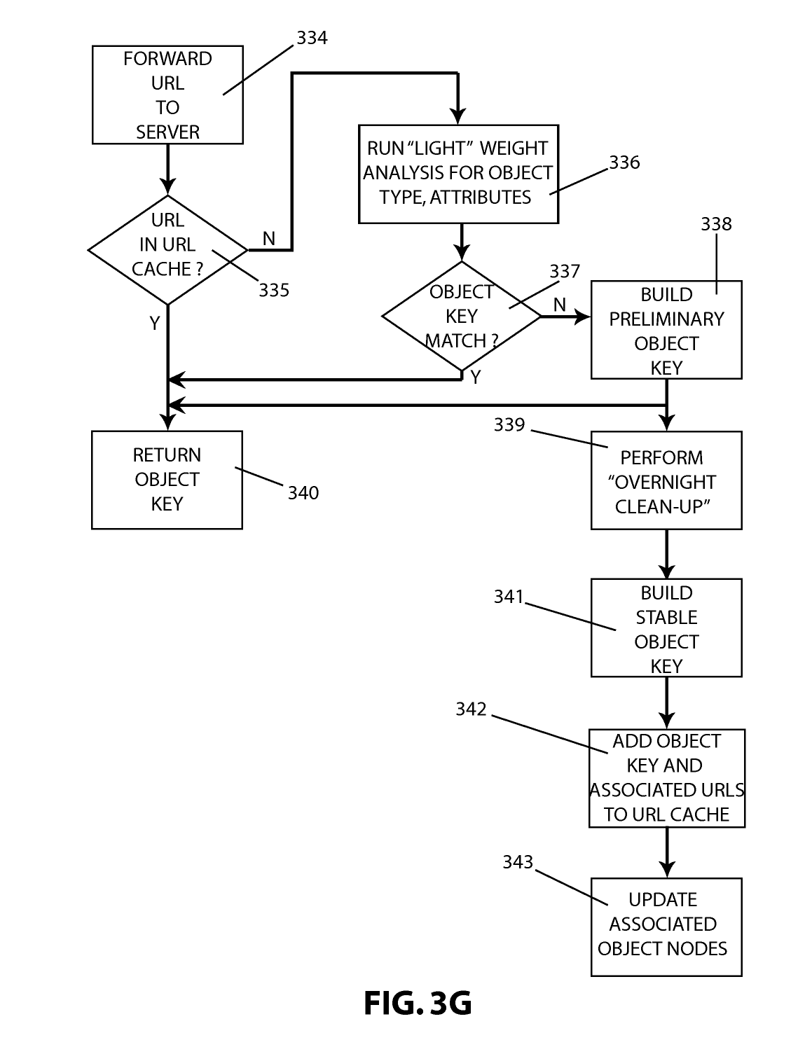

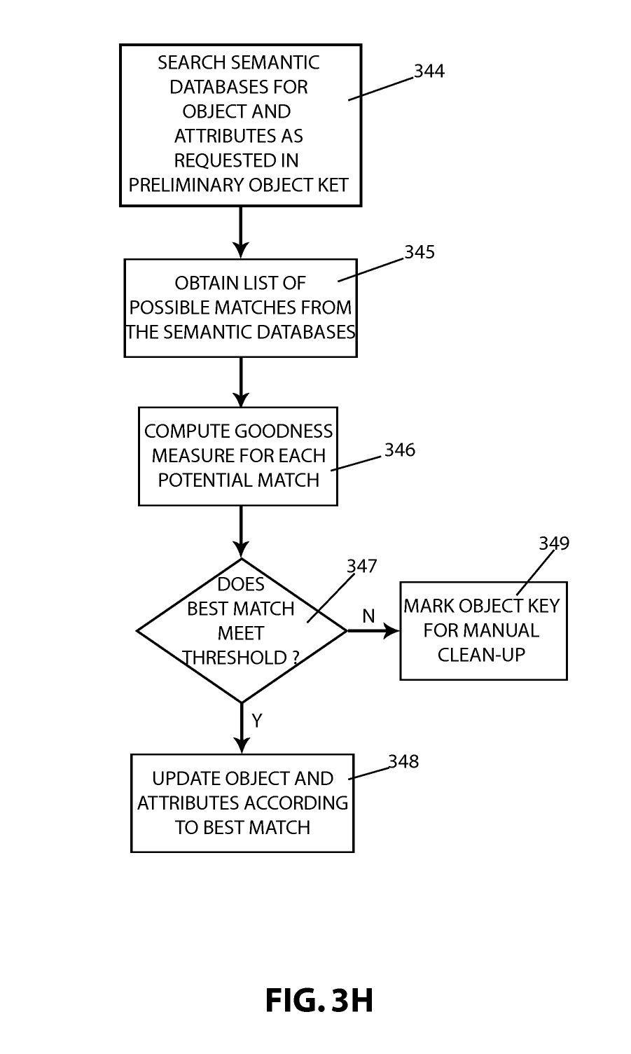

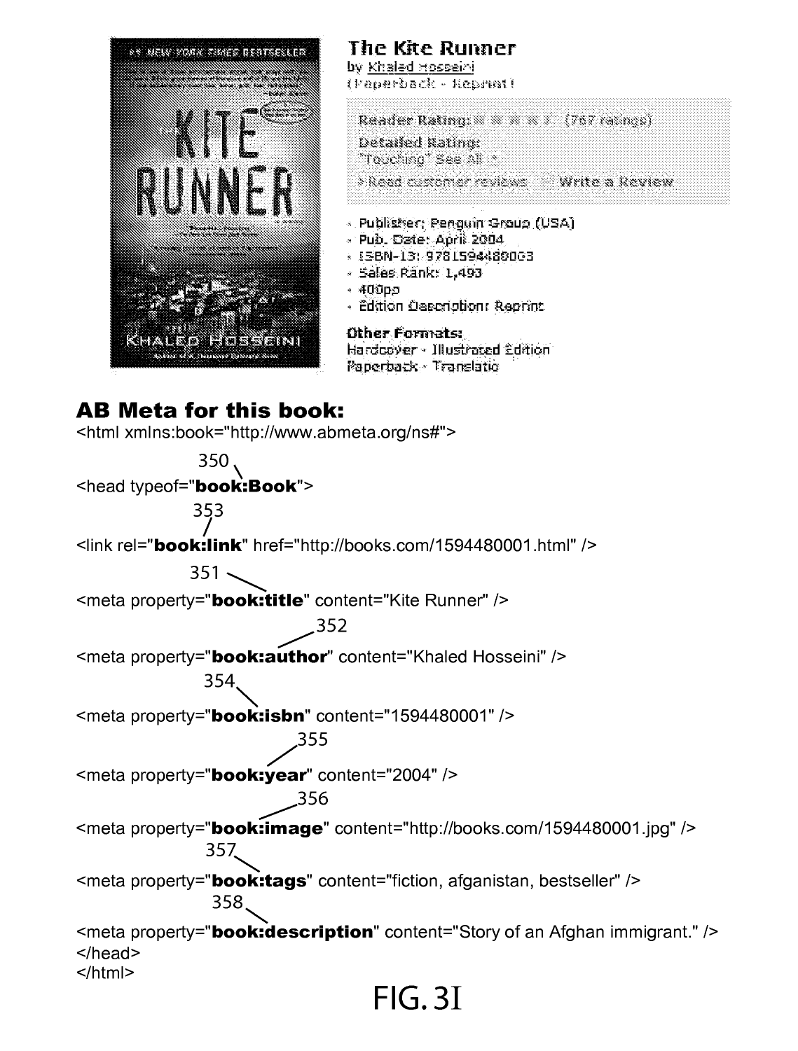

The user may then proceed to create a user profile, as illustrated in the flow diagram of FIG. 3A. For example, the user profile may be created via an “Edit Profile” pane provided by the plug-in and displayed by the browser. As illustrated in FIG. 3A, the user profile creation process begins at step 301 with the selection of a user name by the user. The browser plug-in queries a user database of the system at step 302 to determine whether the submitted name is available, accepts the name if it is available, and queries the user for an alternate name if the name is unavailable. The user may optionally provide additional user information (“2cents About me”) at step 303 as an introduction to other users.

In addition, the user may optionally elect certain protections at step 304 which govern requests made by other viewers wishing to include the user on an ongoing basis in their contextual social networks (viewers wishing to include the user in their social networks are designated to be “followers” of the user). The protections may include, for example, requiring that the user approve each follower request before the request is honored, or alternatively receiving an email notification announcing each follower at the time his or her request is made and honored. An edit profile pane may also optionally be provided to enable the user to set preferences (for example, regarding inclusion and display of certain features of the system in the user's browser window such as a toolbar for accessing features of the system).

FIG. 3B presents a flow diagram illustrating a procedure for recording a user interaction with an object in a contextual social network according to principles of the present invention. At step 305, a web page is displayed by the browser for viewing by the user. At step 306, information presented on or with the web page is parsed to determine whether an object of the web page is identified in a standard, normalized format (for example, in the AB Meta format described further herein).

If no object is identified in a standard format, the plug-in determines at step 307 whether the URL of the web page is present in a URL cache which is preferably maintained by the social networking server and links the URL to a compact object format (“objectKey”) that describes the object and its attributes in a standard format. If the URL is not in the URL cache, the plug-in at step 308 runs a “light-weight” object analysis to determine a preliminary objectKey for the web page by parsing an object type and associated object attributes from the web page according to particularized rules (“heuristics”). For example, the heuristics may include rules for parsing text in an AMAZON.COM web page when the object is determined to have an object type “movie”.

If the object cannot be identified by any of the above-described methods, the process ends at step 309. Otherwise, at step 310, object information (preferably in the form of the objectKey) is coupled with user information for the purpose of updating certain nodes the contextual social network. Object identification is described in greater detail below with reference to FIGS. 3G and 3H.

FIG. 3C presents a flow diagram illustrating a procedure for updating nodes of the network. At step 311, the object information and user information is received (for example, at the social networking server 110). At step 312, the server 110 determines whether an object node was previously created for the object, and if not, creates an object node for the object at step 313. The server may preferably cause the object node to be created in an object database 114 managed by the database server 112. At step 314, the server causes the user information to be recorded in association with the object node.

Similarly, at step 315, the server 110 determines whether a user node was previously created for the user, and if not, creates a user node for the user at step 316. The server 110 preferably causes the user node to be created in a user database 114 managed by the database server 112. At step 317, the server 110 causes the object information to be recorded in association with the user node.

At step 318, the server 110 proceeds to query the object node in order to identify other viewers who have viewed the object. The other viewers identified in the query may be limited, for example, to a particular number of other viewers (for, example, up to twenty) who have most recently viewed the object (based, for example, on timestamp or queuing information which may be recorded at the object node for each recorded viewing by a viewer).

The server 110 may also query the user node to identify any recorded viewers that have been designated by the user as “friends” to be followed. Information about these friends and the other viewers who have recently viewed the object (“recent people”) is packaged for delivery to the browser window at step 319, and then delivered to the browser at step 320 of FIG. 3D where the information is visually represented at least in part in a toolbar that is, for example, appended to the web page for the object.

As described further herein, the tool bar for the object as presented by the user's browser preferably includes icons for the object, at least a subset of the user's friends and a subset of the recent people. The toolbar also preferably includes buttons for retrieving a complete set of icons for friends, and for retrieving a complete set of icons for recent people. In addition, the toolbar preferably includes buttons that enable the user to indicate that he or she likes the object (“I like this”), and to add additional comments about the object (“My 2¢”).

FIG. 3E presents a flow diagram illustrating a procedure for responding to a user selection of the object icon. At step 321, the user selects the icon (for example, by performing a mouse click over the icon). A panel is displayed in the browser window, defaulting to one of the categories of “Actions” People,” or “Summary” (steps 322-324). The default panel preferably provides buttons or links to other categories which the user may select if he or she prefers to display a panel directed to a category other than the default.

If the “Summary” category is selected by the user at step 324, the plug-in causes the browser at step 325 to display a summary panel that preferably presents identifying information for the object, the object icon and a textual description of the object. The textual description may be derived, for example, from a textual description presented at a predetermined web page that presents the object. This information be transmitted to the browser at step 319 of FIG. 3C, stored at the browser after a prior viewing, or retrieved by from the predetermined web site at the time that the summary category is selected by the user.

If the “People” category is selected at step 323, the plug-in causes the browser at step 326 to display a summary panel that preferably displays at least a larger subset of icons of friends or recent people, and includes a “Next” button for displaying additional subsets icons of friends or recent people, and a button for switching between the display of icons for friends and for recent people.

If the “Actions” category is selected at step 322, the plug-in causes the browser at step 327 to display a summary panel that displays links for taking a set of actions that have been selected according to an object type of the object. A suitable method for preparing the action links is disclosed in co-pending U.S. patent application Ser. No. 12/187,343, entitled “Multiple-Link Shortcuts Based On Contextual Analysis of Web Page Objects,” which was filed by the present inventors on Aug. 6, 2008, and is hereby incorporated by reference in its entirety herein.

FIG. 3F presents a flow diagram illustrating a procedure for responding to a user selection of another viewer. At step 328, the user selects an icon for the selected viewer (for example, by performing a mouse click over the icon). A panel is displayed at step 329 in the browser window, which preferably displays profile information of the viewer including an icon (for example, a picture, avatar or other icon) of the viewer, a viewer name, and descriptive information for the viewer if available (“2cents About Me”). In addition, at step 330, the panel is preferably provided with links or buttons for accessing another panel including icons for people being followed by the viewer (“Followed”) or icons for people following the viewer (“Following”).

In addition, at step 331, the panel is preferably provided with icons symbolizing object types for one or more objects that the viewer has marked as liked. Each of these object-type icons may in turn be selected for accessing a panel presents at least a subset of the liked objects for the selected object type, and a “Next” button for viewing additional subsets as required.

Alternatively, at step 332, the panel is preferably provided with at least a subset of icons for “Recently Looked At” objects, and a “Next” button for viewing icons for additional subsets. Finally, at step 333, the panel is preferably provided with “Sites” icons for accessing web pages of the person and/or other social networking sites in which the person participates. Information for constructing the panel created by steps 329-333 (including object and people identifiers associated with a person and links to the person's sites) is preferably accessed at least in part at a people node for the viewer in the people database.

### Object Identification

As described earlier with reference to FIG. 3B, the present invention identifies an object on a web wage semantically in at least one of three ways. First, the plug-in determines whether an object identifier has been placed into the coding for the web page in a standardized, meta-data type format. If no standardized identifier is found, the plug-in then determines whether the URL for the web page is present in a URL cache which cross-references URLs and object identifiers in the form of “objectKeys”, which are compact identifiers that provide links to associated object nodes where more complete object attribute information can be retrieved.

If the URL is not present in the URL cache, the plug-in proceeds to perform an analysis of the contents of the web page according to particularized rules (“heuristics”) to identify the object and its attributes and prepare a preliminary object objectKey. As this latter approach of analyzing the web page to identify the object and its attributes will be necessary to identify any new object or object on a web page associated with a new web page source, it is of particular importance.

FIG. 3G further depicts the processes employed to identify objects when the object of a web page is not explicitly identified using a meta-data format. At step 334, the plug-in, for example, forwards the URL of the web page to the social networking server 110, and at step 335, determines whether the URL is listed in a URL cache maintained by the server 110 (for example, as an AMAZON.COM SIMPLEDB data file). Alternatively, the URL cache may be maintained locally by the plug-in for direct access.

The URL cache preferably caches all URLs that have been viewed by viewers, together with an identifier for the object of each URL viewed. Preferably, each identifier is cached in the form of an objectKey. If a match is found at step 335, the objectKey is returned at step 340 for further processing.

If no match is found in the URL cache at step 335, the plug-in proceeds at step 336 to run a “light weight” analysis of the web page in order to identify the object type, the object and various attributes of the object. This analysis is heuristic, and applies rules based, for example, on the identity of the web page provider and other clues that may be found on the web page together with associated database searches. For example, if application of the heuristic rules yields an object type “book” and a possible title, the plug-in may preferably search a semantic database of books maintained by the social networking server 110 by the apparent title in order to identify additional attributes of the object needed for constructing a preliminary objectKey.

In order to cross-validate any apparent match found in the semantic database, the search may further extend from the semantic database to other sources (for example, other web sites known to feature objects of the type “book”). If, at step 337, a match is found, the semantic database may provide a cross-reference to an associated objectKey and return the objectKey at step 340 for further processing. If not, at step 338, the light weight analysis continues to build a preliminary objectKey by inferring at least an author, book title, and isbn from clues on the web page, and the objectKey is returned at step 340 for further processing. The inference proceeds as follows.

The plug-in begins, for example, by parsing the html code which implements the web page as a parse tree. A series of agents are employed by the plug-in, each agent being responsible for analyzing one attribute of the object. For example, for an object of type “book,” there may be individual agents responsible for analyzing each of the following attributes: “book title,” “author,” “isbn,” and “year.”

Each agent has a “matcher” part and a “grabber” part.” The matcher part walks the parse tree to identify a “neighborhood” (branch) of the tree that appears to contain the object attribute associated with that matcher. The matcher part may, for example, preferably find this neighborhood by applying heuristic rules to identify a “pivot” or inflection point in a certain text string. For example, the inflection point may be identified by text characters that are known to be positioned at the edges or boundaries of a text string to delimit a particular attribute of the object. For example, the string “<title>” on a BARNES & NOBLE web page serves as a delimiter for the attribute “title,” and indicates that a text string specifying the title of a book follows the delimiter.

Once the neighborhood has been identified, the grabber part of the agent is used to extract text and/or other components of the attribute Like the matcher part, the grabber part may also employ heuristic rules to assist with the extraction. For example, the grabber part for extracting the title of the book from the BARNES & NOBLE web page may interpret a non-textual character such as “,” as being a delimiter that concludes the text string for the title of the book.

Once each of the agents completes its analysis, a preliminary set of elements necessary for uniquely and uniformly characterizing the object have been indentified. In order to form the preliminary objectKey, the extracted text is further adapted by a normalization part according to heuristic rules. For example, if the title text string extracted by the grabber part is “War and Peace (Barnes & Noble Classics Series),” the normalization part will strip away the characters that are considered to be non-essential or irrelevant to identifying the title attribute (in this case, “(Barnes & Noble Classics Series)”) to form the normalized string “War and Peace.” In addition, normalization may be used to remove some parenthetical information that was included in the title, or to follow a single consistent rule for capitalization. In this manner, normalized string will most likely be identical to any other title text string for this object that is extracted from any other web page after it is similarly normalized.¹ ¹As the string “and” may be represented by other character strings such as “&” and “+,” the normalization part may also apply heuristic rules may to modify as well as to strip characters in forming the normalized text string.

The preliminary objectKey is linked to an initial object node for the object. However, at step 339, an “overnight clean-up” process is performed to validate the object attributes associated with preliminary objectKey, and thereby the object node. During this process, for each preliminary objectKey produced over a predetermined period (for example, over the last 24 hours), corresponding object information in one or more semantic databases is examined to identify matching objects. Corresponding objects and objectKeys are “cleaned up” based on the full set of available information about the objects, and additional heuristics.

FIG. 3H illustrates a preferred cleaning process according to the present invention. At step 344, a search is conducted for the object and associated attributes of each objectKey.² The search is preferably conducted against a number of databases which have proven to provide good matching characteristics, and in particular, against semantic databases. ³ Possible matches in the search results are identified at step 345, and at step 346, a “goodness” measure is calculated for each potential match to the objectKEY. ⁴ At step 347, the process determines whether the best match exhibits a measure of goodness that exceeds a predetermined threshold. If the best match level of goodness exceeds the threshold, the object and attributes of the objectKey are updated according to information provided by the best match at step 348. ² As URLs and ObjectKeys that have been newly cached will typically each include object and associated attribute information, the cleaning process may also preferably be applied to newly-cached URLs and objectKeys.³ Semantic databases connect objects to each other by means of semantic relationships. As a result, objects (nodes) and relationships (links) are both components of the database structure. This structure is particularly efficient for searching for a number of possible matches for the components of an objectKey (i.e., an object and its related attributes). Suitable databases, for example, may include AMAZON.COM's ECOMMERCE service, the NETFLIX web site, the FREEBASE database, the LAST.FM web site, the GOOGLE FINANCE web site, and others.⁴ For example, goodness may be calculated as a Levenshtein distance between each match and the objectKey, or using any other suitable distance metric for measuring the degree of similarity between two text strings or sequences.

If the best match falls below the threshold (for example, if no match is found at all), the preliminary objectKey is marked at step 349 for a manual cleaning process and/or for resubmission to automated cleaning at a later date.

Returning to FIG. 3G, if a measure of goodness for a matching preliminary objectKey and best match exceeds the predetermined threshold, a “stable” objectKey for each object is established after the cleaning process at step341.⁵ ⁵ Of course, there is come possibility that the “stable” objectKey may in fact be further modified as the result of a subsequent clean-up process.

At step 342, the stable objectKey and all associated URLs are added to the URL cache. In addition, objectKey and URL information at each associated object node is updated.

Object identification may be simplified in cases where an object identifier has been placed into the coding for the web page in a standardized, meta-data type format like AB Meta.⁶ By way of example, a book publisher can use AB Meta to provide information about a book such as the author and ISBN, a restaurant owner can provide information such as the cuisine, phone number and address and a movie reviewer can annotate reviews with movie titles and directors. The AB Meta format allows site owners ⁶See, e.g., AB Meta website. to describe each object on a web page using standard AB Meta headers, and provides the following advantages:
Object-centric: AB Meta can easily be applied to everyday objects that are encountered around the web.
Semantic: AB Meta upgrades pages to be part of growing Semantic Web.
Lightweight: AB Meta does not require a complex markup, or changes to the body of the document.
Intuitive: the names of things and attributes used by AB Meta are understandable by people.
Efficient: object information can be obtained without parsing an entire HTML page
Standards Compliant: AB Meta complies with the Resource Description Framework-in-attributes (RDFa) for the XHTML markup language as recommended by the World Wide Web Consortium (W3C).⁷ ⁷ See, e.g., RDFa primer at W3C website.

FIG. 3I presents an example of the AB Meta format as applied to a book (“Kite Runner”). An object.type header 350 declares that the page is about a book. Additional headers 351, 352 specify the title and the author, respectively. These headers represent a minimum set of information required to identify an object of the type “book.”

In addition to this minimum set, additional headers may be added to provide a more precise identification of the object and/or richer description. For example, a link 353 may be provided to a reference web page for the object (for example, for obtaining a summary description of the object). An ISBN 354 may be provided as an alternate identifier of the book. Additional identifying information may include a publication year 355, an image 356 for providing a “thumbnail” picture of the book cover, tags 357 to indicate relevant categories for characterizing the book, and a description 358 as an alternative to the summary description provided by the link 353.

AB Meta may preferably be used, for example, to express single or multiple objects of the following types: Apparel, Album, Blog, Book, Gadget, Item, Movie, Movie Star, Recipe, Recording Artist, Restaurant, Stock, TV Show, Video Game, and Wine. Example formats for each of these object types are provided below, together with an indication of which of the associated headers may be required and which are optional:

| | | |
|---|---|---|
| Header | Required | Notes |

album

| | | |
|---|---|---|
| album:artist | yes | Allows multiple values. |
| album:year | no | Format: YYYY |

blog

| | | |
|---|---|---|
| blog:author | no | Allows multiple values |

book

| | | |
|---|---|---|
| book:author | yes | Allows multiple values. |
| book:isbn | no | 10 or 13 digit standard |
| | | ISBN number. |
| book:year | no | Format: YYYY |

gadget

| | | |
|---|---|---|
| gadget:manufacturer | yes | Commonly known name |
| | | of the manufacturer |
| gadget:model | yes | Manufacturer specific |
| | | model number. |

item

| | | |
|---|---|---|
| item:manufacturer | yes | Commonly known name |
| | | of the manufacturer |

movie

| | | |
|---|---|---|
| movie:director | yes | Allows multiple values. |
| movie:starring | no | Allows multiple values. |
| movie:year | no | Format: YYYY |

movieStar

| | | |
|---|---|---|
| movieStar:hometown | no | |
| movieStar:birthday | no | Format: MM/DD/YYYY |
| movieStar:filmography | no | Allows multiple values. |

recipe

| | | |
|---|---|---|
| recipe:ingredients | yes | Allows multiple values. |
| recipe:cuisine | no | Allows multiple values. |
| recipe:calories | no | Format: Number |
| recipe:servings | no | Format: Number |
| recipe:time | no | Format: HH:MM |

recordingArtist

| | | |
|---|---|---|
| recordingArtist:hometown | no | |
| recordingArtist:birthday | no | Format: MM/DD/YYYY |
| recordingArtist:discography | no | Allows multiple values. |

restaurant

| | | |
|---|---|---|
| restaurant:address | yes | Format: Street, City State Zip |
| restaurant:phone | yes | Format: 000-000-0000 |
| restaurant:cuisine | no | Allows multiple values. |
| restaurant:pricerange | no | Format: $X-$Y. |
| restaurant:website | no | The home page of the |
| | | restaurant |

stock

| | | |
|---|---|---|
| stock:symbol | yes | Standard US Stock Symbol |
| stock:sector | no | |

videoGame

| | | |
|---|---|---|
| videoGame:manufacturer | yes | Commonly known name |
| | | of the manufacturer |
| videoGame:platform | no | Commonly known name |
| | | of the platform |

wine

| | | |
|---|---|---|
| wine:winery | yes | |
| wine:grape | yes | |
| wine:region | no | |
| wine:points | no | Format: Number |
| wine:year | yes | Format: YYYY |

As previously described, in cases where an object has not been identified on a web page using a standardized, meta-data format like AB Meta, the plug-in determines whether the URL for the web page is correlated with an object identifier in the URL cache, and if not, proceeds to perform an analysis of the web page according to particularized heuristic rules to identify the object-type, the object and its attributes.

### User Interface

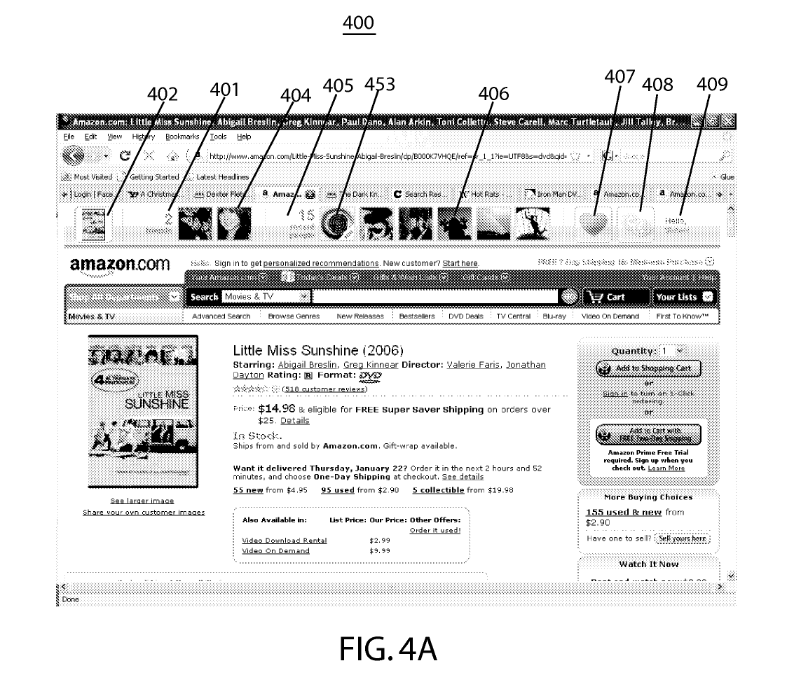

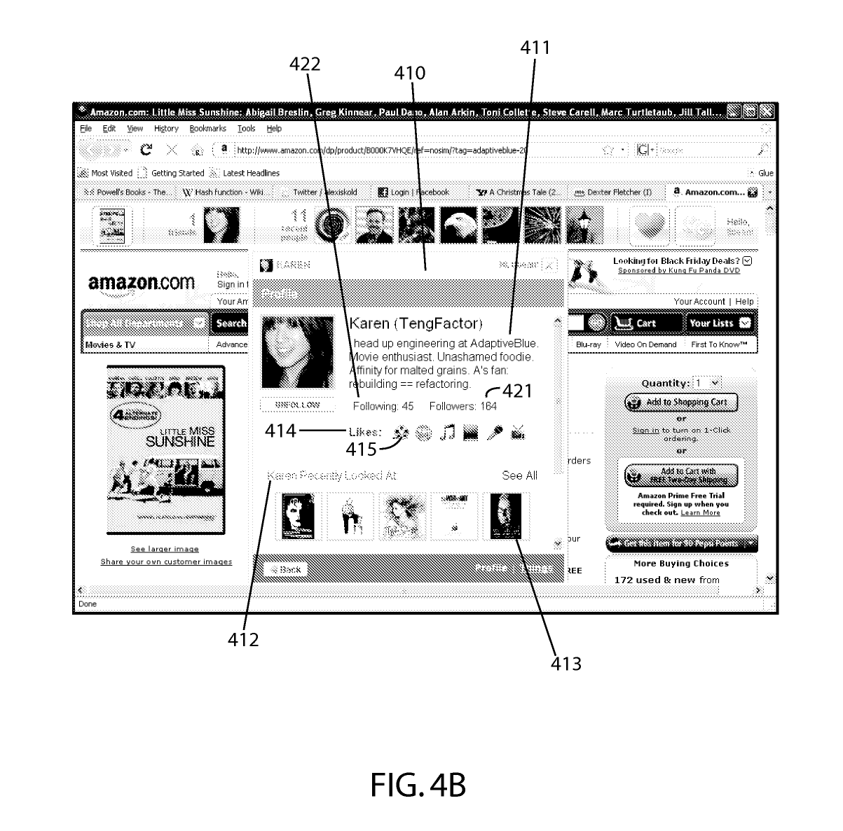

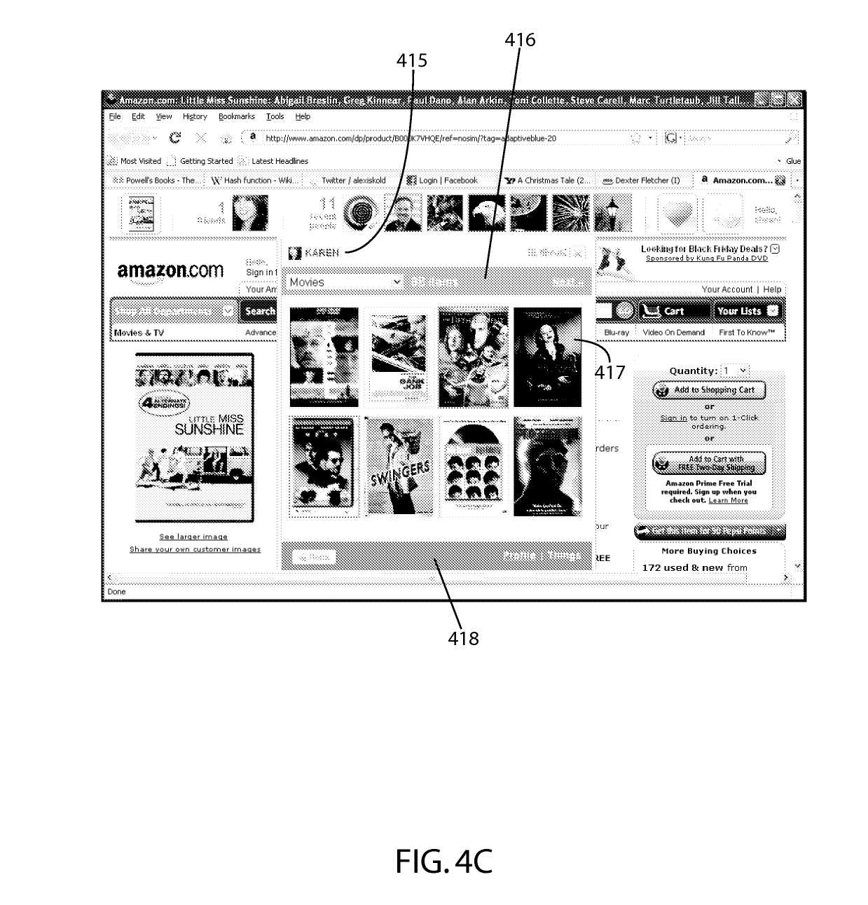

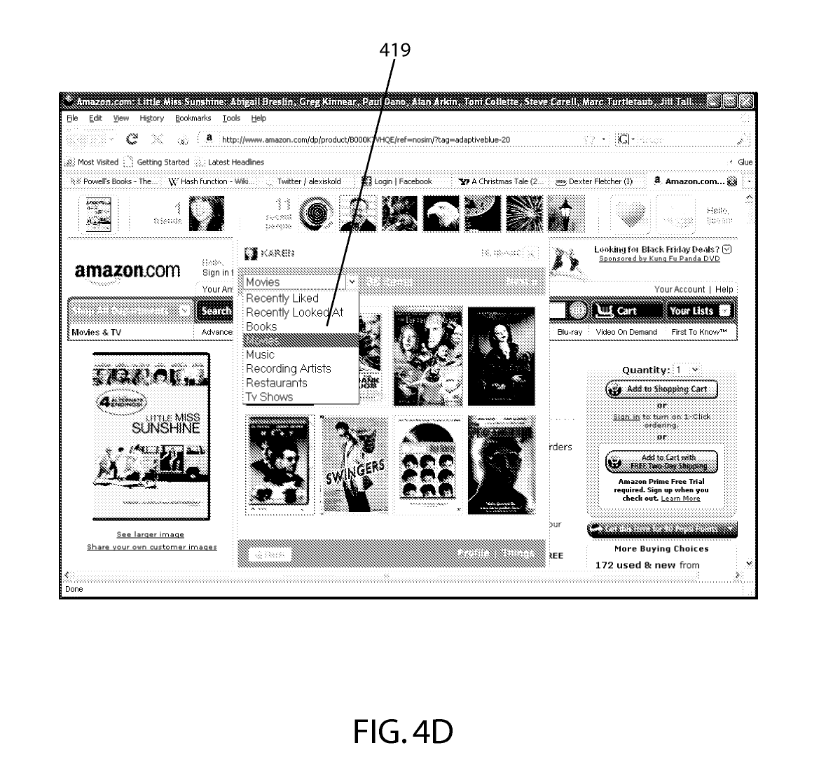

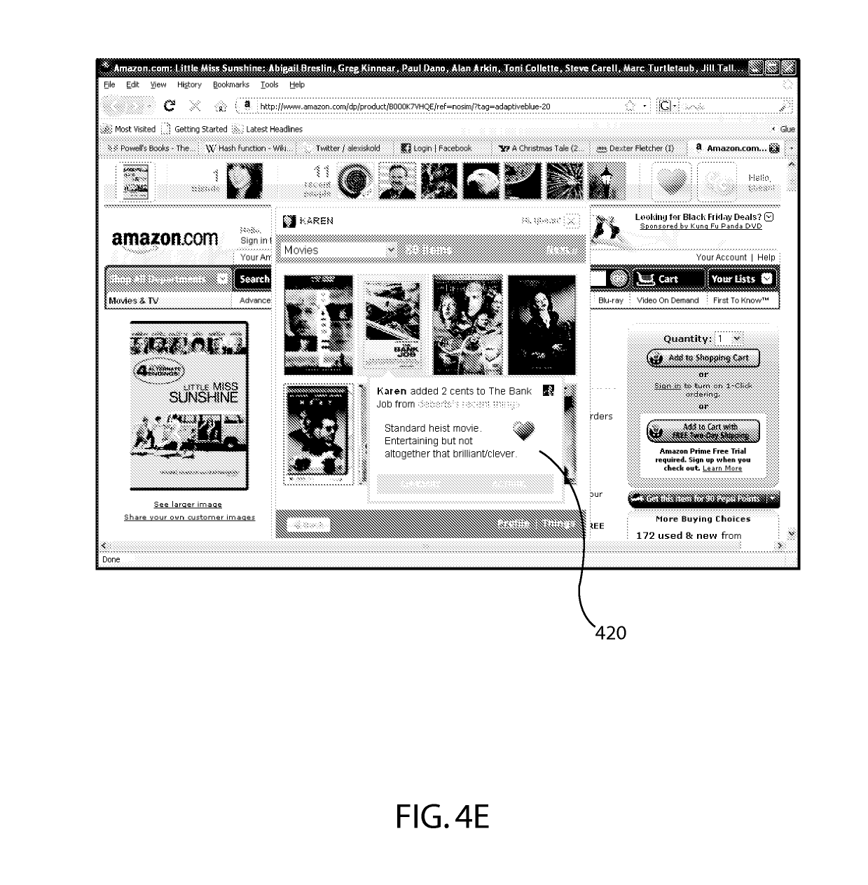

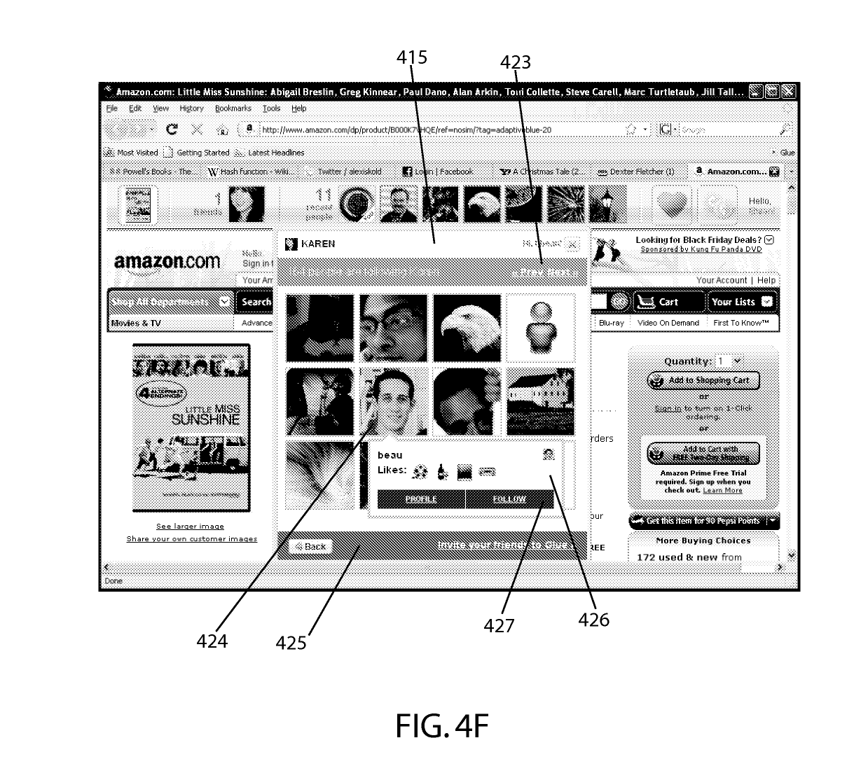

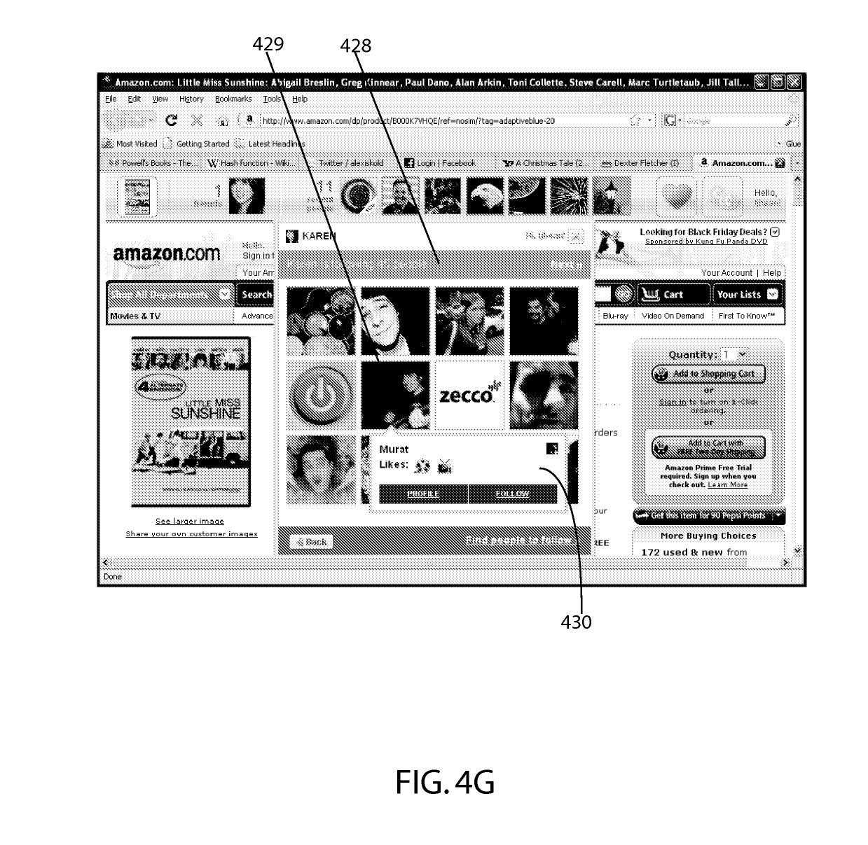

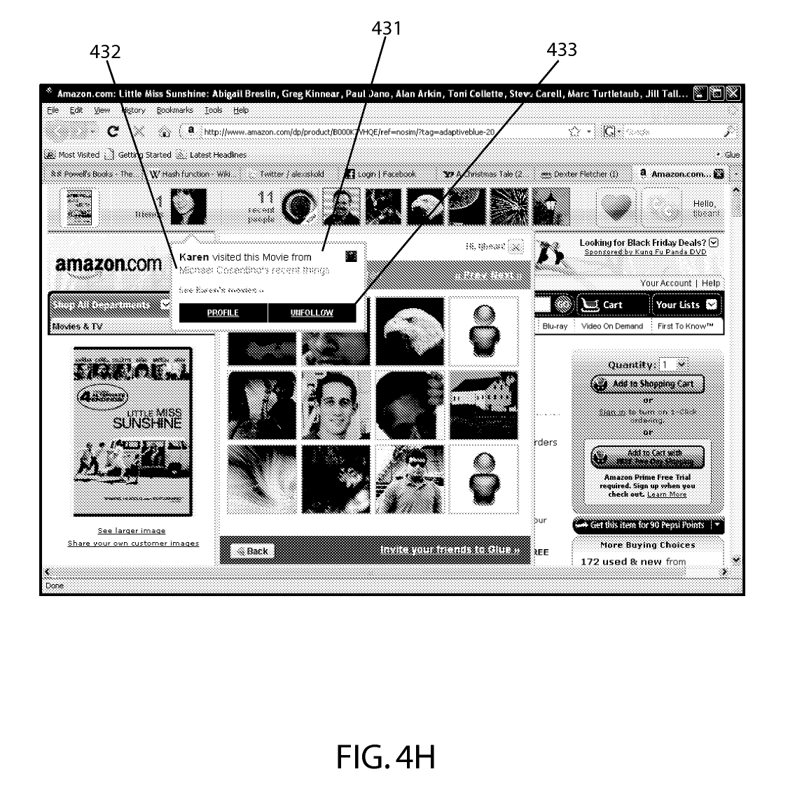

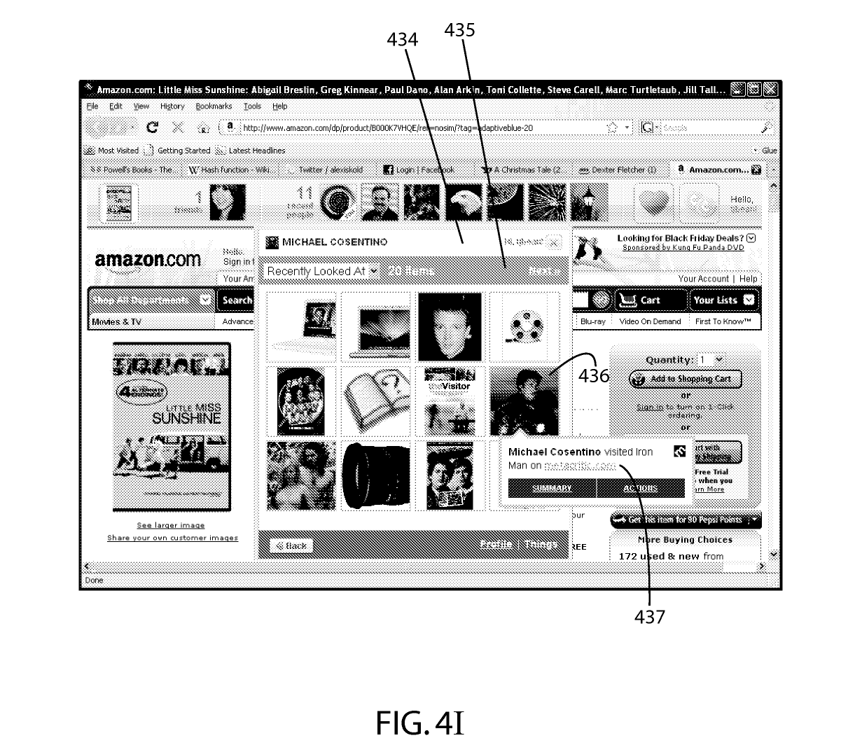

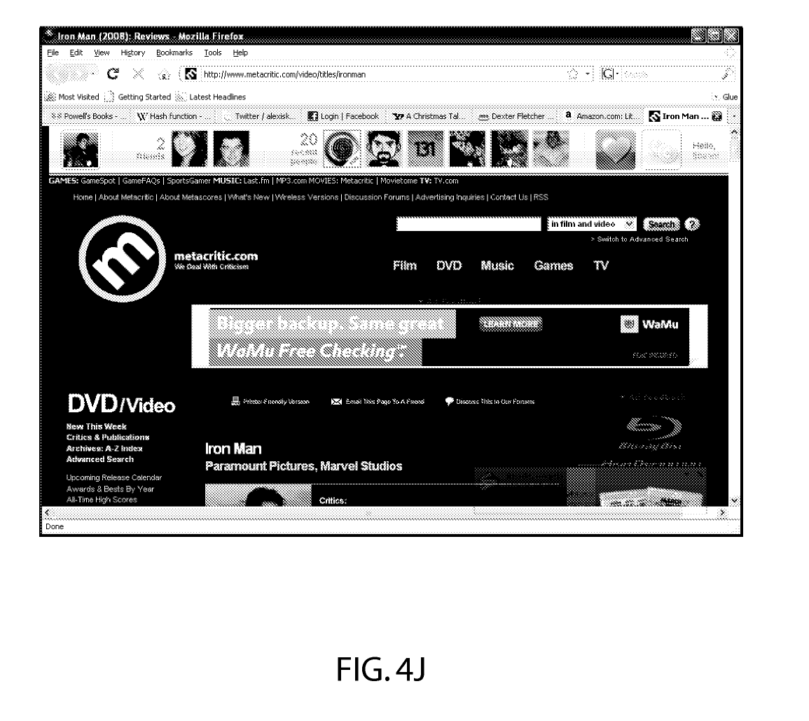

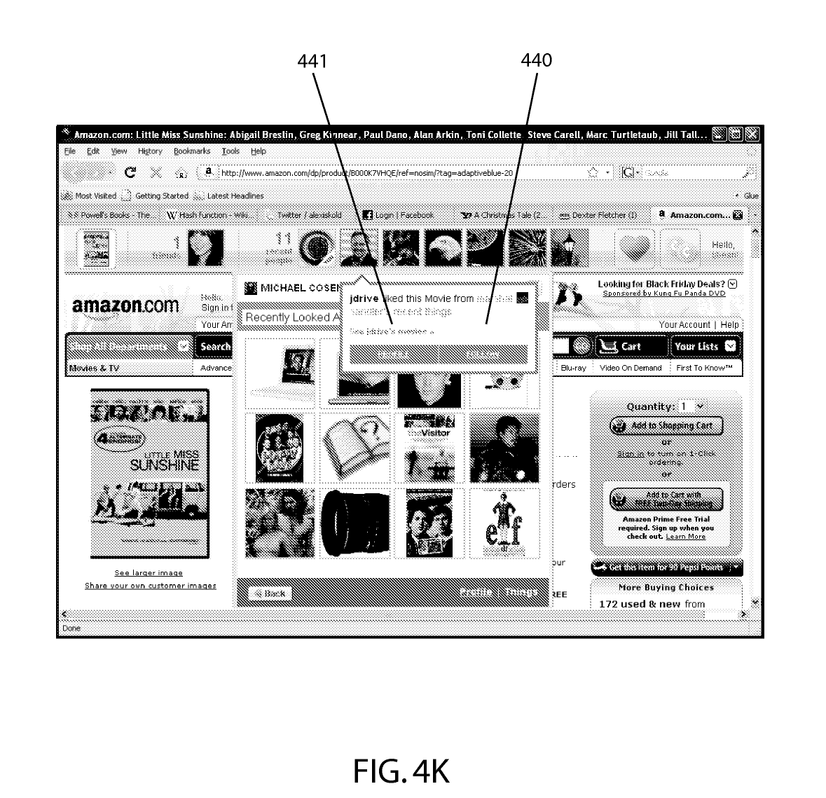

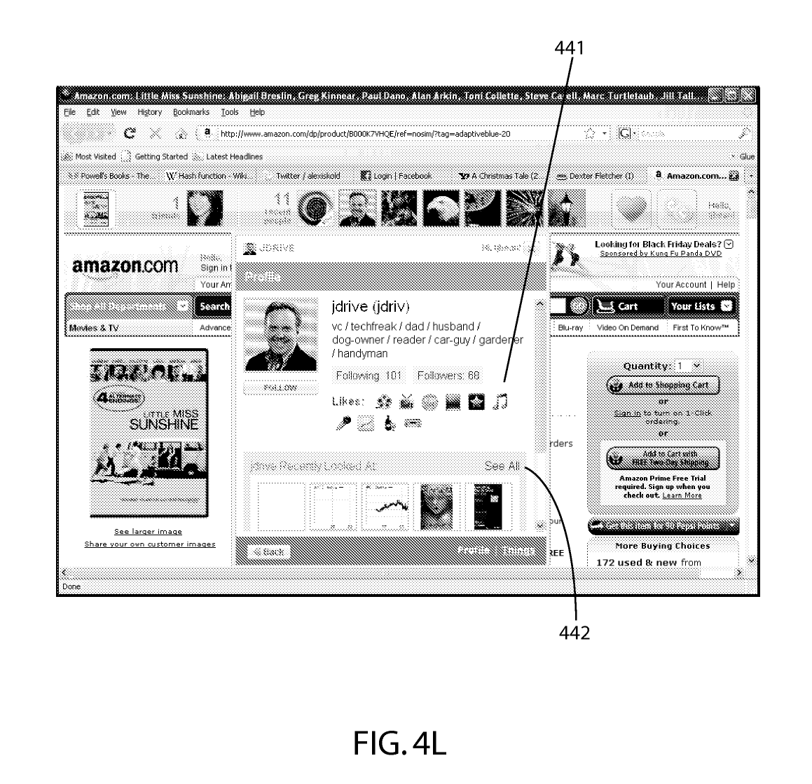

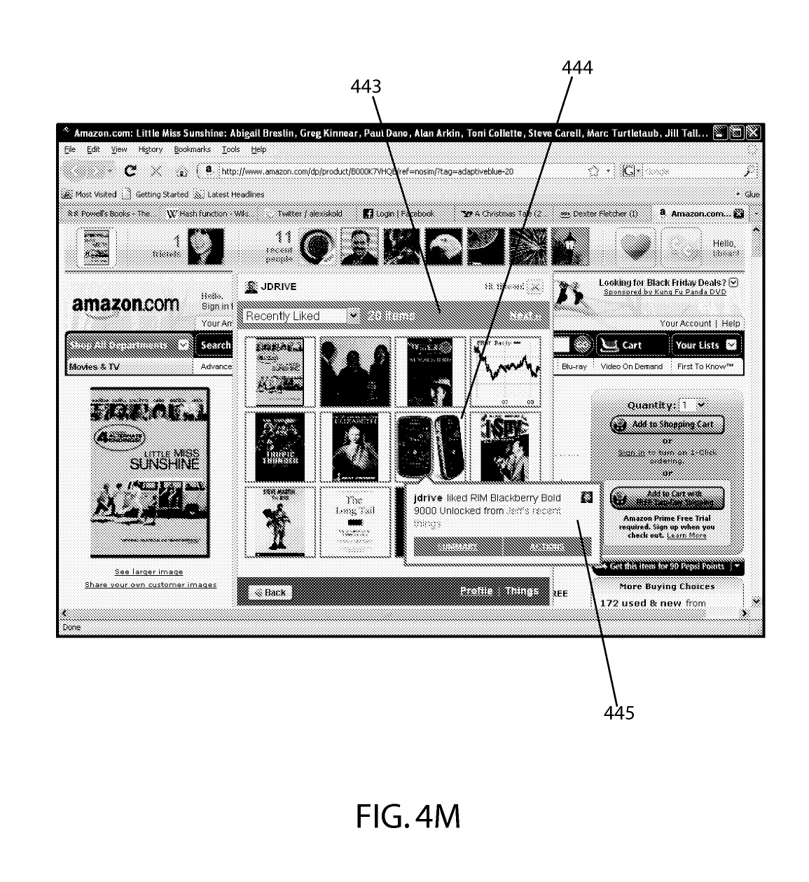

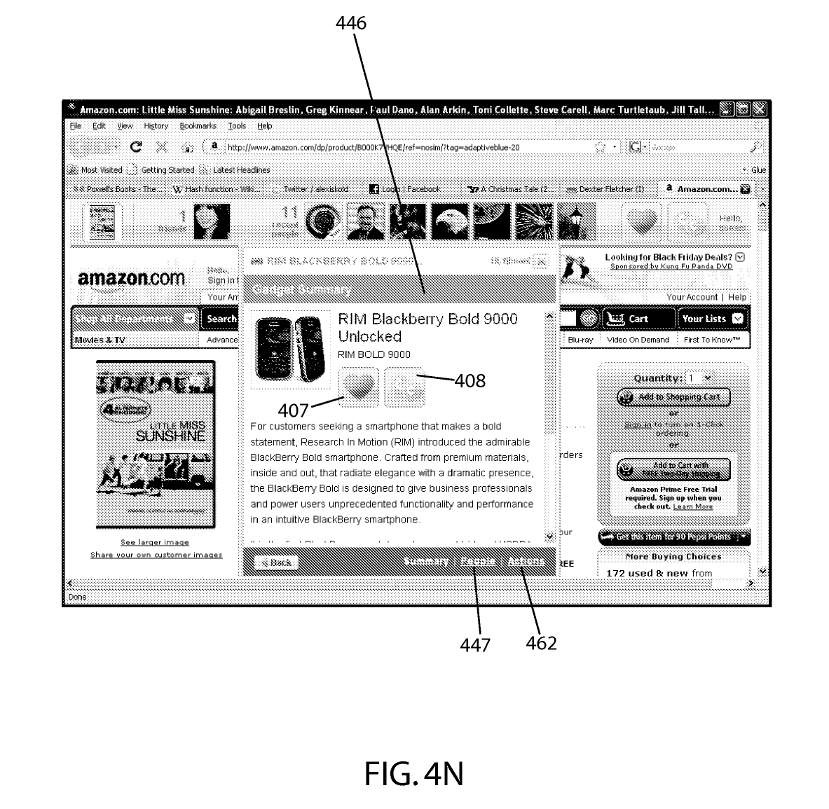

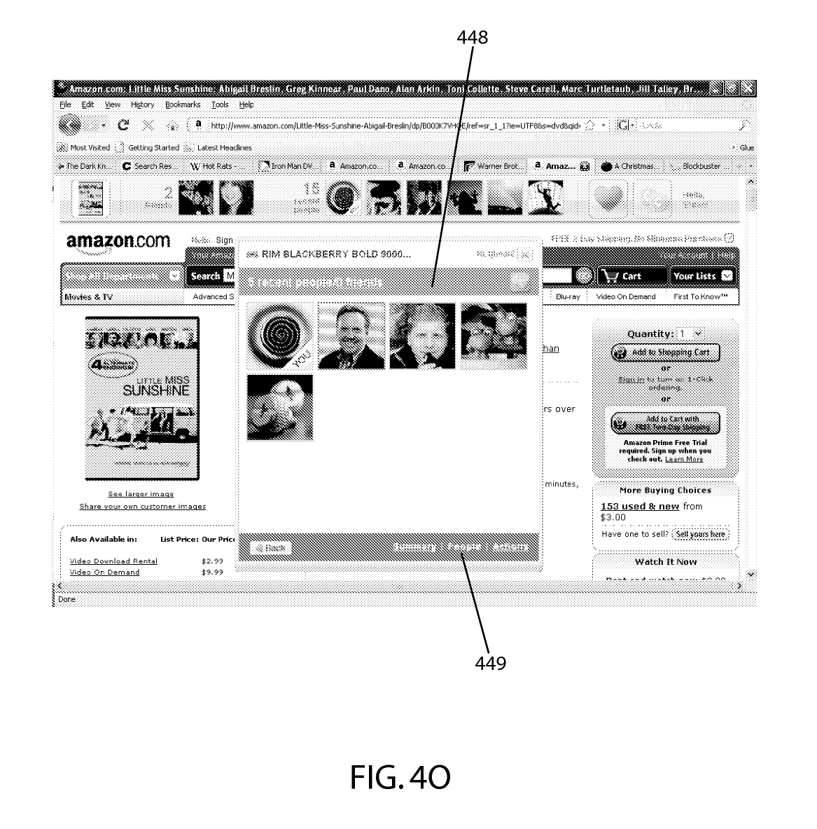

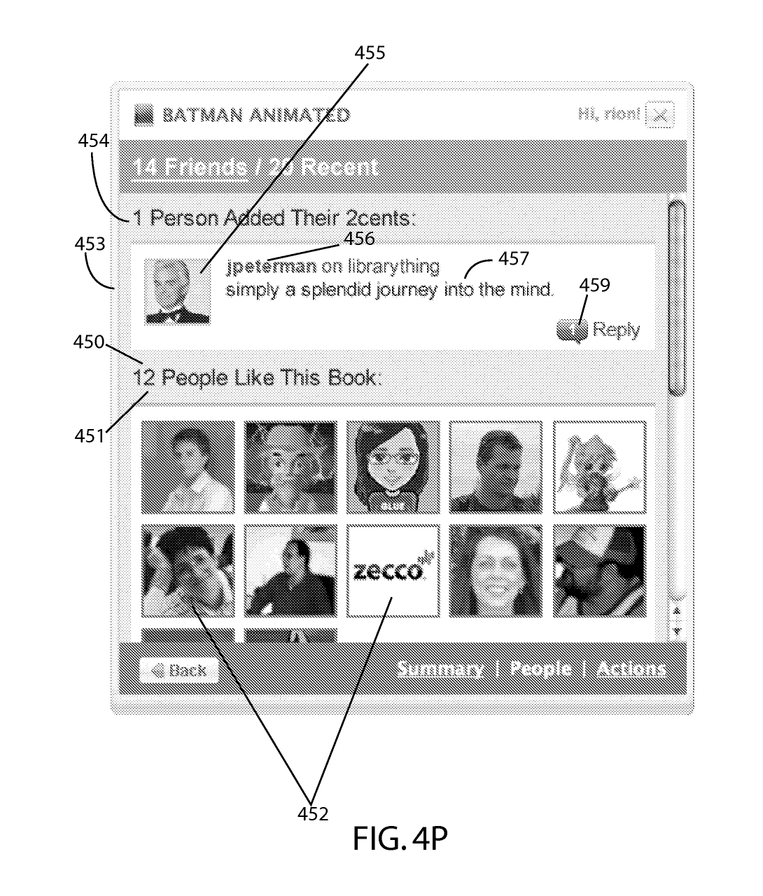

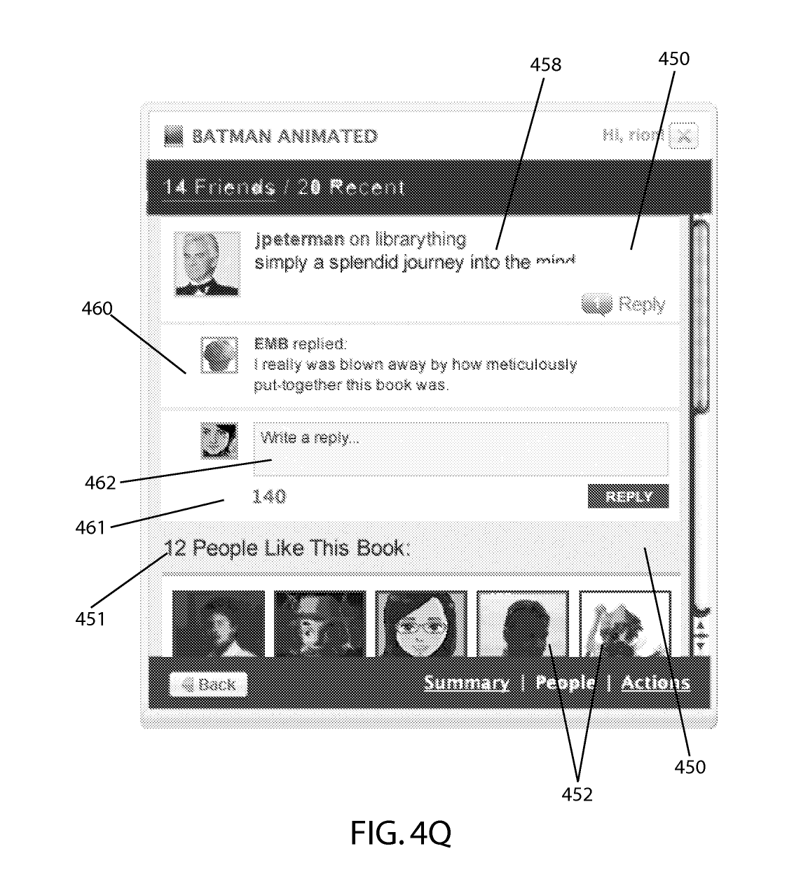

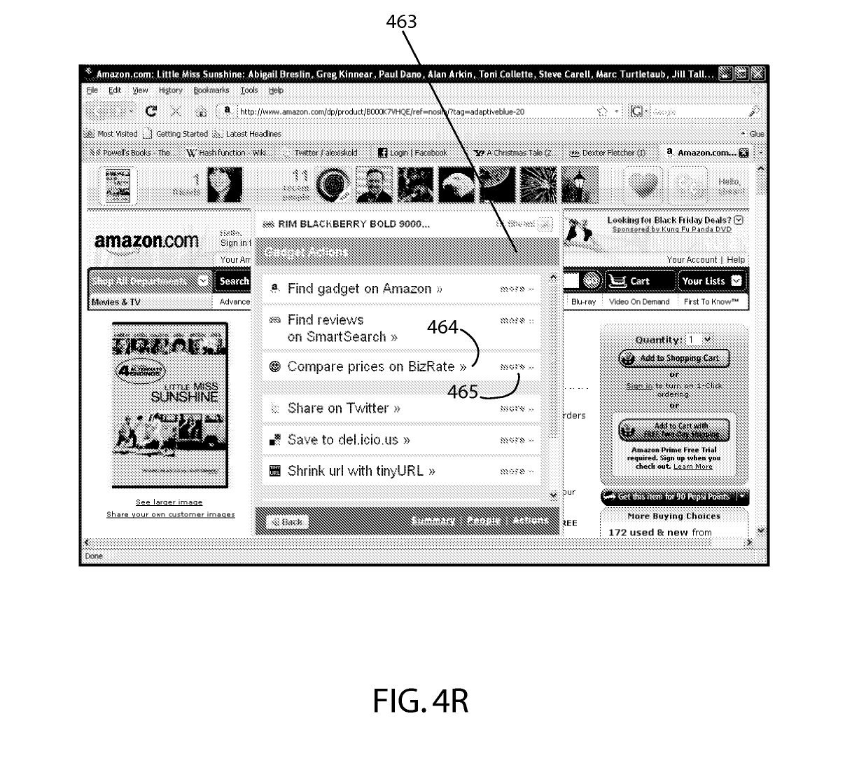

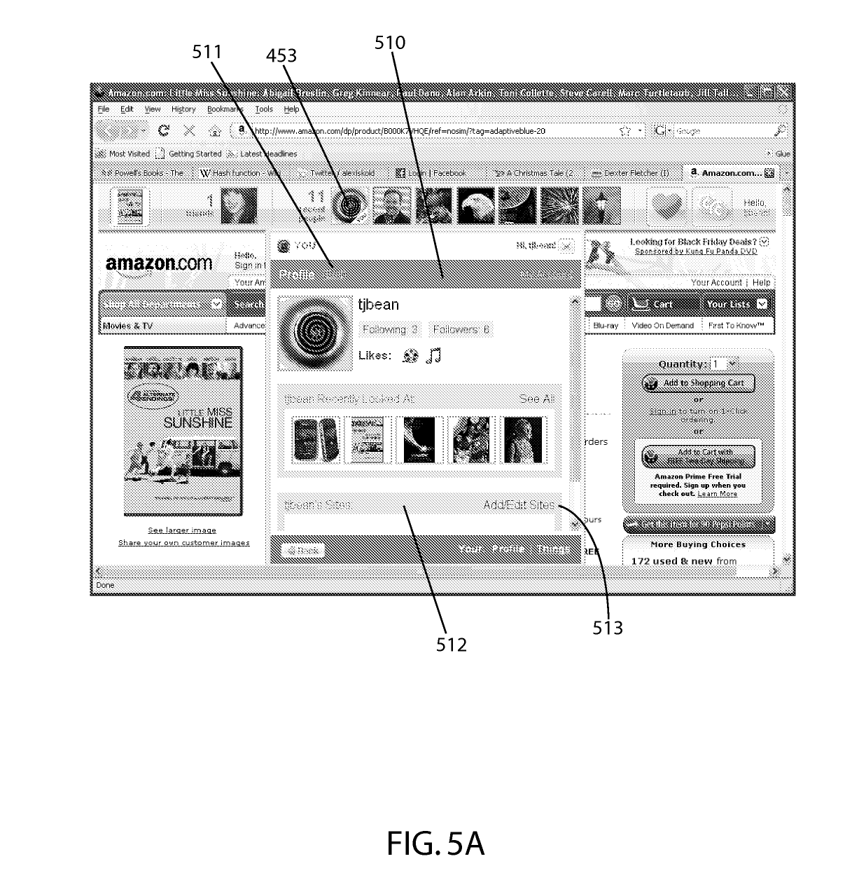

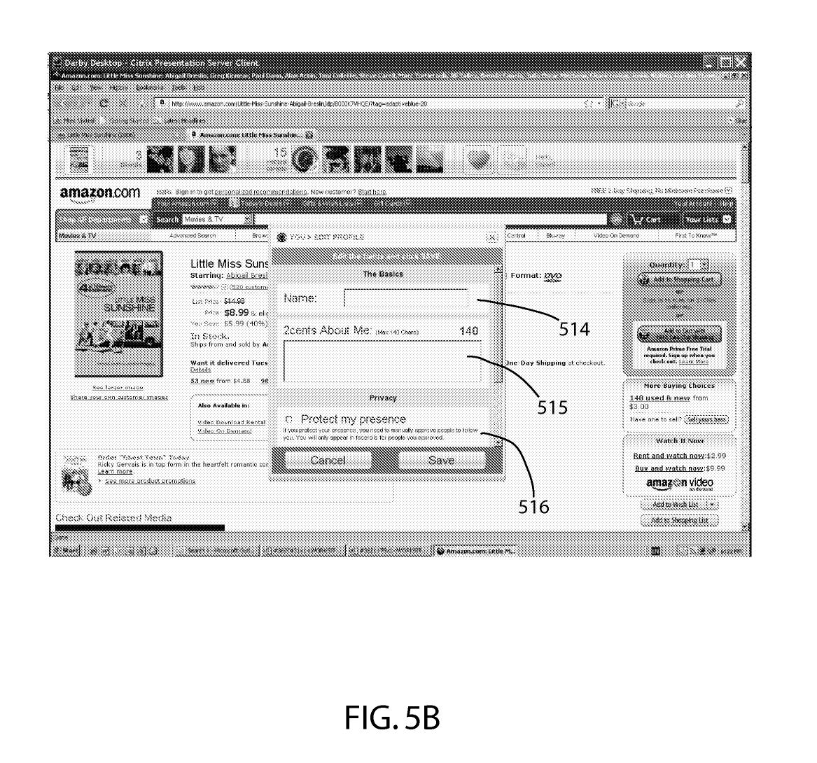

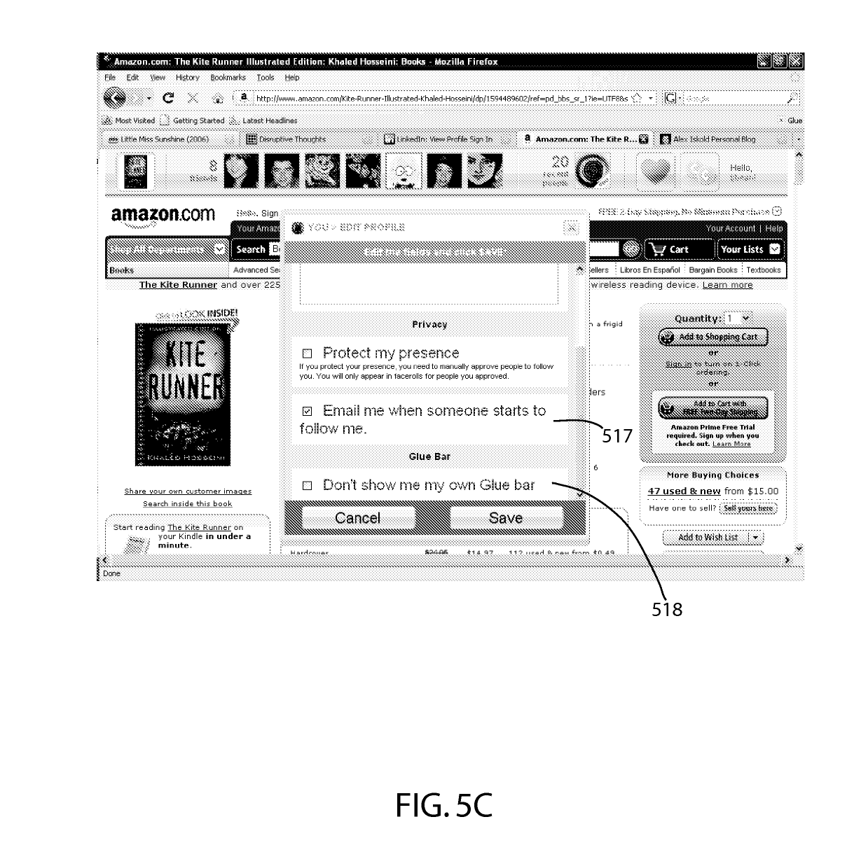

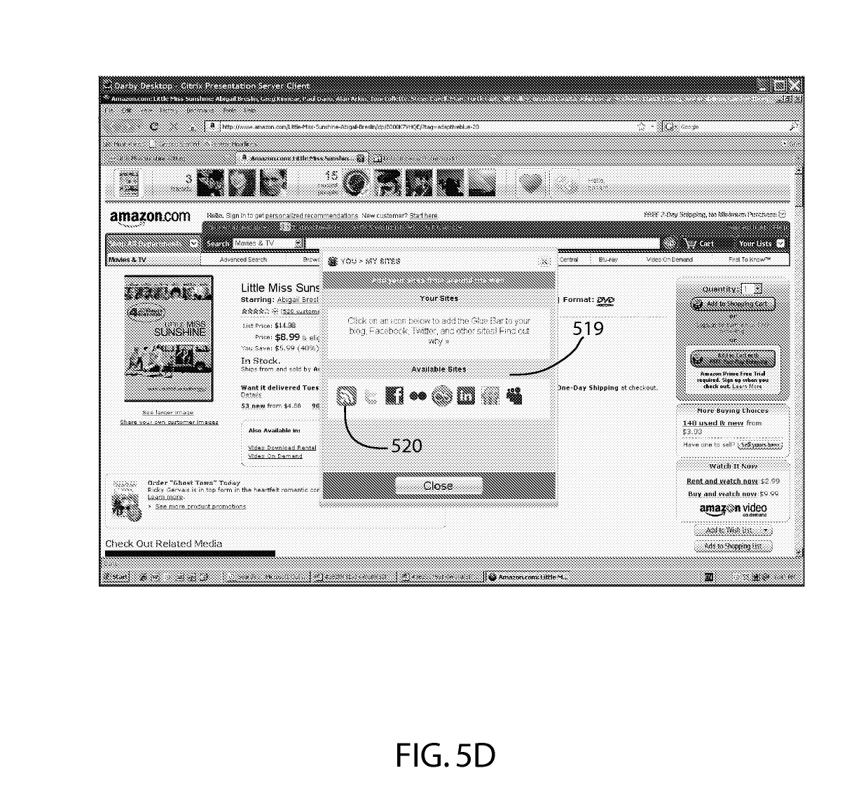

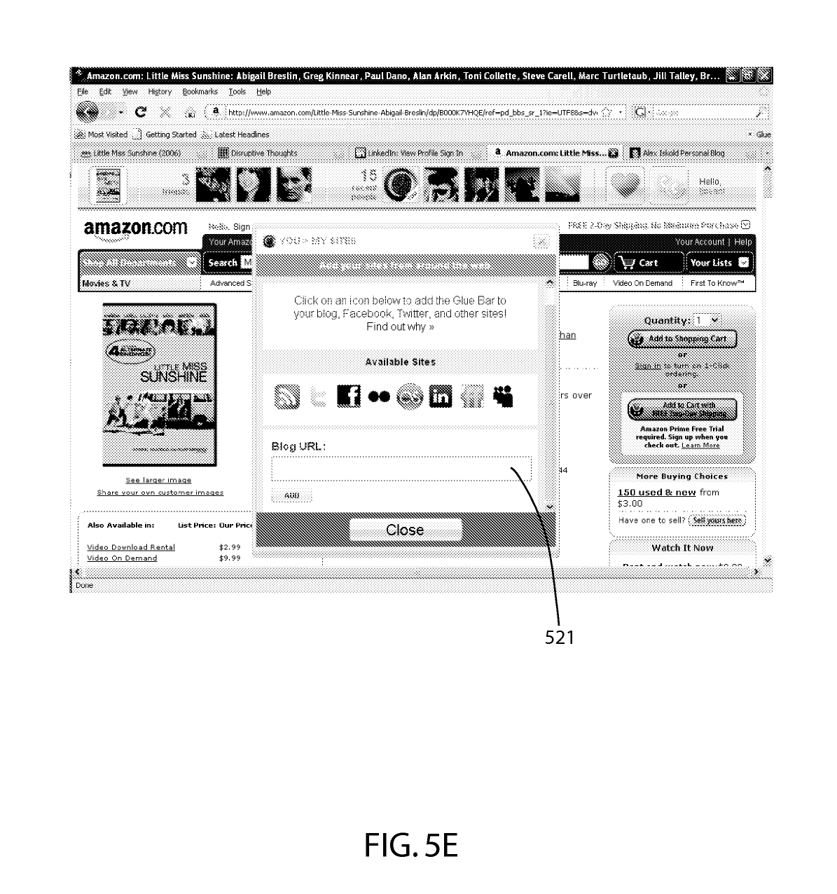

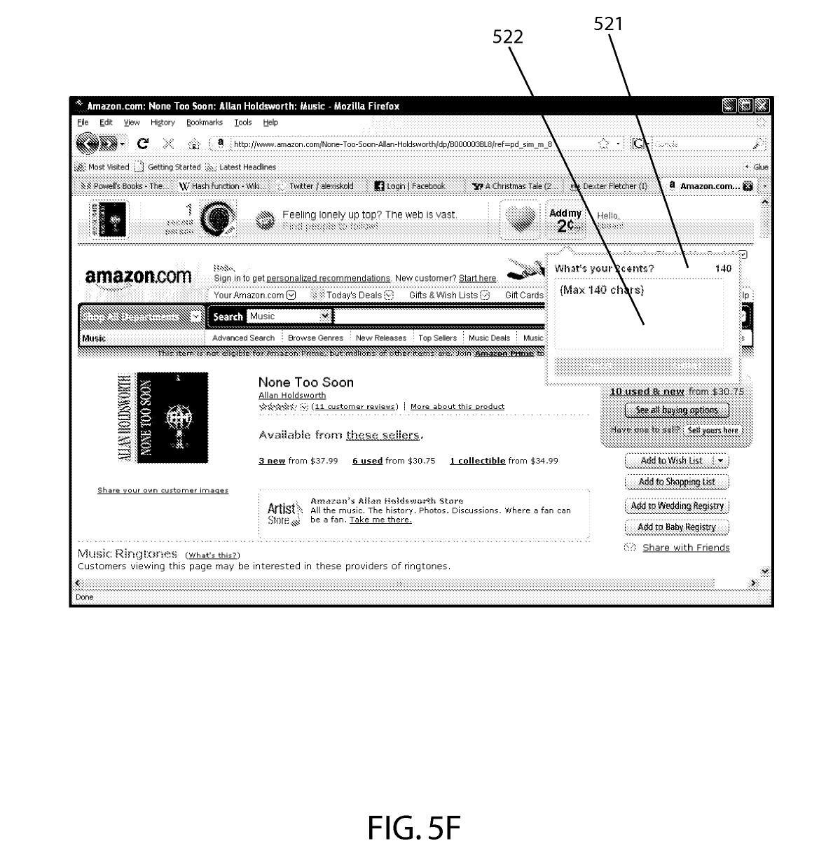

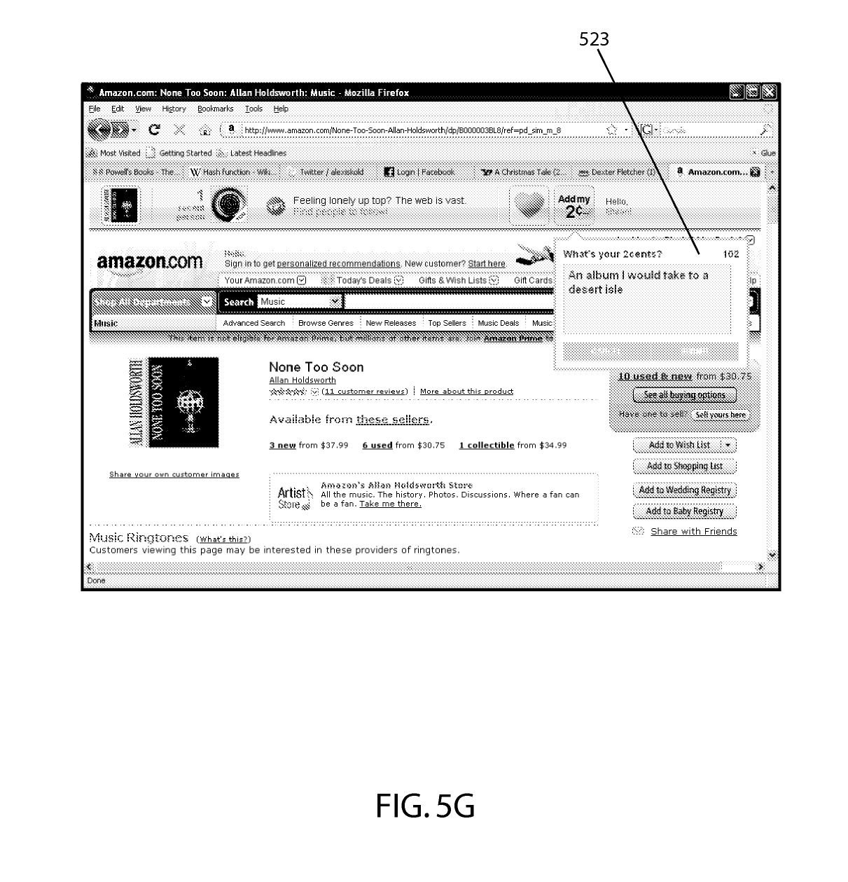

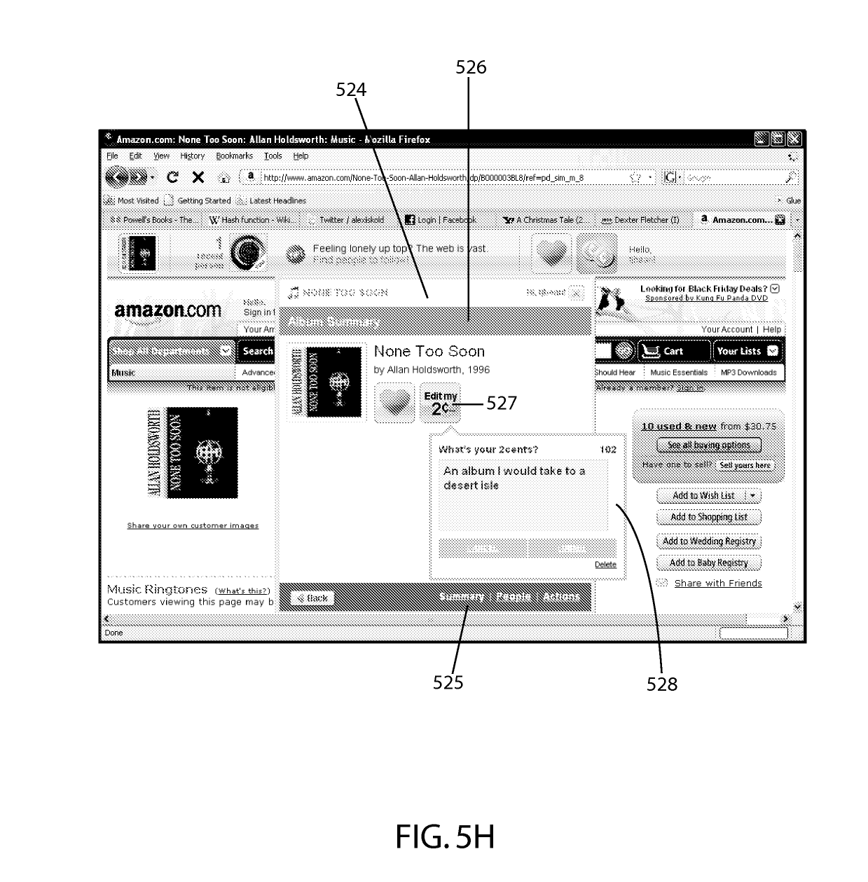

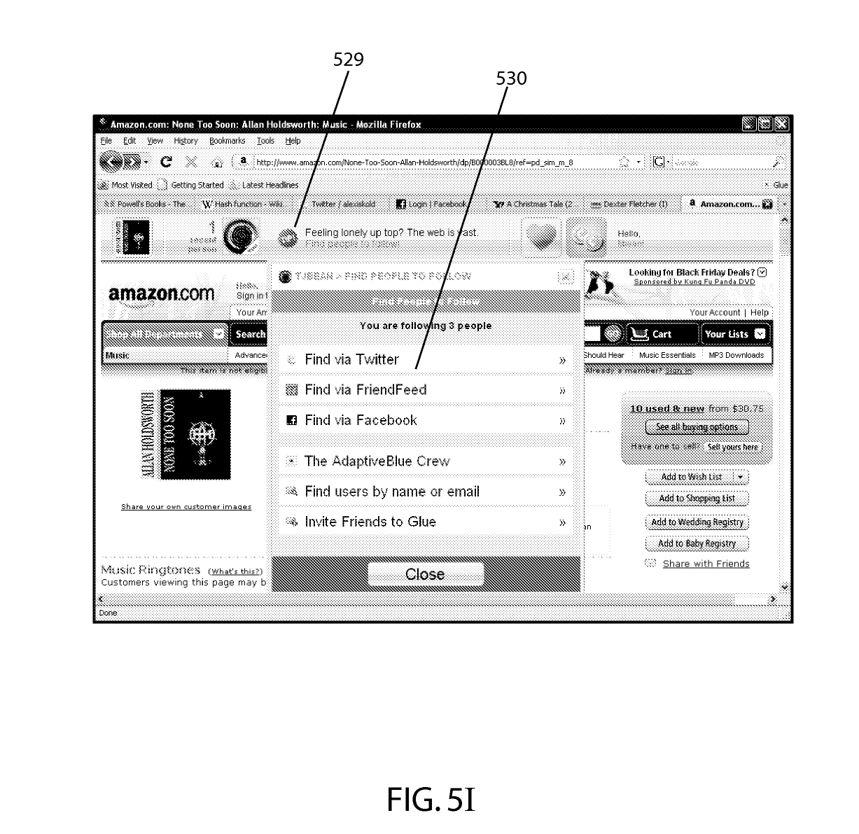

FIGS. 4A-4Y and 5A-5E illustrate exemplary features of the present invention as engaged by a user via a browser.

FIG. 4A illustrates a browser window 400 showing an AMAZON.COM web page for the movie “Little Miss Sunshine.” In this illustrated example, the web page is presented in a browser window created by a FIREFOX browser application provided by MOZILLA. However the web page could alternatively be presented by any of a variety of available browser applications.

When the web page is displayed by the viewer, the plug-in identifies an object of the web wage as described above, and provides an object identified and user identifier to the social networking server 110 in order to retrieve social networking information for display in the browser window. In the example of FIG. 4A, the plug-in creates an associated toolbar 401, and redraws the web page to position this toolbar above the rest of the content at the top of the page. A person skilled in the art will recognize that the toolbar 401 can be alternatively configured in many other ways (for example, along a side or bottom of the page, or inset in a frame within the pages) without veering from the principles of the present invention.

The toolbar 401 as illustrated by way of example in FIG. 4A includes a number of icons. An object icon 402 at the left provides a thumbnail depiction of the object of the web page. Next to the object icon 402, a “friends” region 403 indicates the number of friends of the user who have viewed the object (i.e., the movie “Little Miss Sunshine”) either on AMAZON.COM's web page, or on a web page for this object provided by another source. “Friends” may include people who have been imported by the user from other social networking applications (for example, from FACEBOOK or FLICKR), or may include anyone else that the user discovers and identifies as a friend.

Within the friends region 403, friends icons 404 are provided to depict at least a subset of friends who have viewed the object. A subset is provided when the space allocated for friends region 403 is insufficient to display the icons for all friends of the user who have viewed the object, and may be selected according to any one of a number of predetermined criteria. For example, icons may be selected in the order of friends who have most recently viewed the object, friends who have recorded comments about the object, and so on. In a preferred embodiment, the criteria used may be directly selected by the user and recorded in a user profile.

Adjacent to the friends region 403 of the toolbar 401 is a “recent people” region 405. Recent people include viewers who have recently viewed the object and have not previously been identified by the user as friends. The region 405 indicates the number of recent people who have viewed the object. This number may be selected, for example, to represent the number of people who have most recently viewed the object, up to a predetermined number (for example, up to 20 people who have most recently visited). Alternatively, the number may be selected to represent the number of people who have viewed the object during a predetermined period of time (for example, the number of people who have viewed the object in the last 48 hours). Otherwise, the number may be effectively unlimited.

Within the recent people region 405, recent people icons 406 are provided to represent at least a subset of the friends who have viewed the object. As with the friends icons 404, a subset of recent people icons 406 is provided when the space allocated for the recent people region 405 is insufficient to display the icons of all recent people who have viewed the object. The subset may be selected according to any one of a number of criteria. For example, the subset of icons may be selected in the order of people who have most recently viewed the object, people who have recorded comments about the object, and so on. In a preferred embodiment, the criteria used may be selected by the user and recorded in the user profile.

Adjacent to the recent people region 405 is an “I like this” icon 407, which can be selected by the user to simply indicate and record a favorable reaction to the viewed object. Adjacent to the I like this icon 407 is an “Add my 2¢” icon 408, which can be selected by the user to add comments providing a more detailed impression by the user for the object. The impression may preferably be limited to a maximum number of characters or words (for example, 140 characters). The user may select either or both of these features.

At the right end of the toolbar 401, a user greeting 409 greets the user by the user's user name.

FIG. 4B illustrates a profile 410 for a friend which is provided, for example, in a pane that appears when the user clicks on an icon 404 for the associated friend. The profile 410 may preferably provide a “2¢ About Me” summary 411 that has been provided by the friend for introductions to others, a “recently looked at region” 412 presenting object icons 413 for objects recently viewed by the friend, and a “likes” region 414 for highlighting objects that the friend has selected as liked by selecting the I like this icon 407. In the present example, the likes region 414 presents object-type icons 415 for further grouping and organizing the objects liked. For example, the object linked to reference numeral 415 in FIG. 4B is an object type icon for movies.

The present invention contemplates supporting object types essentially without limitation. In the present example, icons are shown for object types including movies (movie reel), restaurants (dinner plates), music (eighth note doublet), books (book cover), recording artists (microphone) and TV shows (TV set).

FIG. 4C illustrates another pane that appears when the movie type object in the likes region 414 of the friend's profile 410 is selected by the user. In this pane, an identification bar 415 identifies the associated friend, and a summary bar 416 identifies that the number of movies that the friend currently likes and provides a drop-down for jumping to another window concerning objects of another object type that are liked by the friend. FIG. 4D illustrates a drop-down 419 of other object types.

Object icons 417 in FIG. 4C illustrate at least a subset of the movies liked by the friend. If the objects illustrated are just a subset of the movies liked, a scrolling button “Next>>”) is provided in the summary bar 416 for moving to a next group of object icons. A navigation bar 418 enables the user to move back to a previous pane, or to the friend's profile 410.

By performing a mouse-over over one of the movie icons 417 of FIG. 4C, a details balloon 420 preferably appears as illustrated in FIG. 4E. The details balloon 420 identifies the friend (“Karen”), indicates whether the friend liked or added her 2¢ for the movie identified by the icon 417, and identifies where the friend viewed the object on the web. It should be noted that it is possible to indicate that the object was viewed at a web page provider page (i.e., AMAZON.COM), or alternatively, at a pane for a friend profile 410 or profile for a recent person as illustrated in FIG. 4E.

Returning to FIG. 4B, the profile 410 may also provide buttons 421, 422 for accessing information about “followers” of the friend and information about others who the friend is “following”, respectively. As illustrated, the button 421, 422 indicate a current number of “followers” and a current number of people that the friend is “following,” respectively. In the present context, anyone who is being followed will be treated as a “friend” of the follower (for example, by being indentified and counted as a friend in the friends region 403 of the toolbar 401 in the browser window of the follower).

FIG. 4F illustrates another pane that appears when the followers button 421 is selected by the user. In this pane, the identification bar 415 identifies the associated friend, and a summary bar 423 identifies that the number of people that are following the friend. Followers icons 424 are provided for at least a subset of the followers of the friend. A scrolling button (“<<Prev Next >>”) is provided in the summary bar 423 for moving either to a next or previous subset of followers icons 424. A navigation bar 425 enables the user to move back to a previous pane, or to invite others to join the contextual social network of the present invention.

By performing a mouse-over over one of the followers icons 424, a details balloon 426 appears. The details balloon 426, for example, identifies the follower (“beau”), provides a likes region with associated object type icons for accessing objects liked by the follower, and a profile button for accessing the follower's user profile. In addition, the details balloon 426 preferably includes a “follow” button 426, which may be clicked by the user to enable the user to follow the follower of the user's friend. The user may choose to follow this follower, for example, after looking at the objects liked by the follower and concluding that the user and the follower share a common interest.

By selecting the following button 422 of FIG. 4B, the pane of FIG. 4G appears. In this pane, the identification bar 415 continues to identify the associated friend. A summary bar 428 identifies the number of people that are being followed by the friend (in other words, the friend's friends). Following icons 429 are provided for at least a subset of those who are being followed by the friend. By performing a mouse-over over a following icon 429, a details balloon 430 appears. The details balloon 430 identifies the person being followed (“murat”), provides a likes region with associated object type icons for accessing objects liked by the person being followed, a profile button for accessing that person's user profile, and a “follow” button to enable the user to follow the friend's friend.

As illustrated in FIG. 4B, a profile pane 410 for a friend is provided, for example, when the user clicks on an icon 404 for the associated friend. Alternatively, as illustrated in FIG. 4H, by performing a mouse-over over the icon 404, a details balloon 431 appears. The details balloon 431 identifies the friend (“Karen”), and provides a link 432 for accessing the object presently being viewed by the user (the movie “Little Miss Sunshine”) at the web page, viewer profile or other source where the friend viewed the this object. In addition, the details balloon 431 preferably provides another link to other objects of the same object type (“Movies”) that the friend liked, and a profile button for accessing the profile 410. In addition, an “unfollow” button 433 is preferably provided for enabling the user to remove the friend from the group of friends the user is following. This unfollow button may also be preferably provided in the friends profile 410 of FIG. 4B.

By selecting the viewing link 432 (“Michael Cosentino's recent things”) in the details balloon 431, the pane of FIG. 4I appears. In this pane, an identification bar 434 identifies the source (viewer “Michael Cosentino”), and a summary bar 435 provides a drop-down for jumping to another object grouping (for example, from “Recently Looked At” to liked “Books,” “Electronics” or “Movies”). Icons 436 are provided for at least a subset of the objects in a current object grouping (in this case, “Recently Looked At” objects).

By performing a mouse-over over one of the object icons 436, a details balloon 437 appears. The details balloon 437, for example, identifies the viewer (“Michael Cosentino”), and provides a link 437 for accessing the associated object (the movie “Iron Man”) at the web page, viewer profile or other source where the viewer viewed this object (web site “METACRITIC.COM”). In addition, the balloon 437 preferably includes a summary button 438 for accessing, for example, a “thumbnail” description of the object, and an “actions” button 439 for performing certain actions relating to the object.

Upon selecting the link 437, the user's browser retrieves the associated METACRITIC.COM web page, as illustrated in FIG. 4J.

With reference to FIG. 4A, when the user performs mouse-over over one of the recent people icons 406 of the toolbar 401, a details balloon 440 appears, for example, as illustrated in FIG. 4K. The details balloon 440 identifies the recent person (“jdrive”), and indicates whether the recent person visited, liked and/or added his 2¢ for the object that is currently being viewed by the user (the movie “Little Miss Sunshine”). The details balloon 440 preferably provides a link 441 for accessing this object at the web page, viewer profile or other source where the recent person viewed it (“marshal sandler's recent things”), and provides a link 442 to view other objects of the same object type (“movies”) that the recent person has liked or commented on. The details balloon 440 also preferably includes a profile button and a follow button as previously described.

FIG. 4L illustrates a pane presenting a recent person profile 443, which appears, for example, when the user selects the profile button in the details balloon 440 or selects the recent person icon of FIG. 4A. The recent person profile 443 is similar to the friend profile of FIG. 4B, with the exception that a follow button is preferably provided in the profile 443 instead of an unfollow button.

By selecting a “See All” button 444 in recent person profile 443, icons for all recently looked at items are presented in the pane (or for a subset of recently looked at items if the total number of icons are to large to present in the pane). A summary bar 445 as illustrated in FIG. 4M appears above the pane in the recent person profile 443, and includes a drop-down for jumping to another window concerning an object of another type. For example, as shown in FIG. 4M, a “Recently Liked” object type has been selected, and a subset of all recently liked objects is presented in the pane. A scrolling button (“Next>>”) is provided in the summary bar 445 for moving to a next subset.

By performing a mouse-over over an icon 444 for one of the recently liked objects, a details balloon 445 appears. The details balloon 446, for example, identifies the recent person (“jdrive”), and provides a link for accessing the liked object (“RIM Blackberry Bold 9000) at the web page, viewer profile or other source where the recent viewer viewed it. In addition, the details balloon 447 preferably provides a summary button for the liked object and an actions button as previously described.

Upon selecting the summary button in the details balloon 447, another pane appears presenting an object summary 448 as illustrated in FIG. 4N. The object summary 448 preferably presents an object identifier together with an object icon and a textual description of the object (provided, for example, from a predetermined source such as an associated web page provided by a pre-identified web page provider). In order to enable this information to be retrieved and presented, the associated object node may store the summary information, or may store a link to the associated web page of the predetermined source.

The object summary 448 may preferably include the “I like this” icon 407 and “Add my 2¢” icon 408 of FIG. 4A to easily enable the user to indicate and record a favorable reaction or comment in regard to the object. In addition to summary and actions buttons, the object summary 448 preferably adds a “People” button 449. As illustrated in FIG. 4O, upon selecting the people button 447, another pane appears presenting a people summary 450 for the object. In the people summary 450, links are provided for toggling between recent people and friends who have viewed the object (the gadget “RIM BLACKBERRY BOLD 9000). In a navigation bar 451 at the bottom of the pane, links are provided for toggling between the summary for the item, people and actions.

In another embodiment of the present inventions as illustrated in FIGS. 4P and 4Q, toggling to friends in the people summary 450 causes a pane portion 452 to be displayed of people (friends) who have viewed the object (book “Batman Animated”) and marked the object as being liked. Pane portion 452 presents a number of friends 453 who marked the object as liked, and presents icons 454 representing at least a subset of these friends.

Another pane portion 455 identifies the number of friends 456 that added their 2¢ in regard to the object. The pane portion 455 preferably provides an icon 457 for each friend together with an identifier 458 for the friend, an identifier 459 indicating the web site on which the friend viewed the object and the friend's 2¢ 460. In addition, the pane portion 455 presents a balloon 461 that indicates the number of people who have replied to the friend's 2¢ 460.

By clicking or mousing over the balloon 461, entries 462 are presented for each person that has replied. As illustrated in FIG. 4Q, each entry 462 preferably includes an icon and an identifier of the replying person, and comments made by the replying person. In addition, clicking or mousing over the balloon 461, a blank entry 463 is preferably presented with an icon for the user and an entry box 464 fir the user to enter his or her reply to the friend's 2¢.

FIG. 4R illustrates a panel that appears when the actions link or button 465 id FIG. 4N is selected. An Actions summary 466 appears, together with action buttons 467 which are selected as actions that are relevant for objects of the present object type (“Gadget”). A suitable method for preparing the action buttons 467 is disclosed in co-pending U.S. patent application Ser. No. 12/187,343 (“the '343 Application”), which was filed by the present inventors on Aug. 6, 2008, is entitled “Multiple-Link Shortcuts Based On Contextual Analysis of Web Page Objects,” and is hereby incorporated by reference in its entirety herein. The '343 Application discloses a multiple-link “shortcut” pane which is associated with an object and is dynamically constructed to provide links and other types of information based on an identified object type of the object. The action buttons 467 typically enable a particular action to be taken with a particular resource (for example, comparing prices for the gadget at the BIZRATE web site). A “more” link 468 is preferably provided on each action button 467 to enable the user to alternatively select the same or a similar action to the action button 467 to be taken with an alternate resource (for example, comparing prices at the PRICE GRABBER web site).

Referring back to FIG. 4A, a user icon 469 is preferably provided at a leftmost portion of the recent people icon area in the recent people region 406 (i.e., as the most recent of recent people viewing the object). As illustrated for example in FIG. 5A, when the user clicks on the user icon, a pane appears including a profile 510 for the user. Distinct from profiles 410 that the user may view for friends and other recent people, the profile 510 for the user includes an edit link 511 to enable the user to edit his or her profile information, and a summary bar 512 of other sites (for example, social networking sites) at which the user has a presence. An “Add/Edit Sites” button 513 is preferably provided on the summary bar 512.

FIG. 5B illustrates a panel that appears when the edit link 511 is selected. The panel includes a “Name” field 514 enabling the user to provide further identification in addition to the user's username, and a “2cents About Me” field 515 for providing additional user information. For example, the user may provide information relating to career, hobbies and other interests to help other viewers determine whether they share any interests in common with the user. In addition, the panel preferably includes a “Protect my presence” checkbox 516 which enables the user to restrict other viewers from following the user unless specifically approved by the user.

The panel of FIG. 5B as illustrated can be scrolled to display additional fields. FIG. 5C illustrates the panel of FIG. 5B after scrolling. An “Email me . . . ” checkbox 517 is provided to enable the user to receive email notification when another viewer has elected to follow the user. A “Don't show me my own GLUE bar” checkbox 518 enables the user to suppress display of the toolbar 401 of FIG. 4A. Each of the features enabled by the checkboxes 516-518 can be later disabled by selecting the edit link 511 and unchecking the associated checkbox.

FIG. 5D illustrates a panel that appears when the add/edit sites button 513 of the user profile 510 of FIG. 5A is selected. The panel presents an available sites area 519 including icons 520 for other sites (for example, other social networking sites) that the user may participate in. By clicking on one of the icons 520, the user opens an ID box 521 as illustrated in FIG. 5E that solicits the user's identification information for the site (for example, a user ID or URL). Clicking on an icon for some sites may alternatively bring the user to a sign-in page for that site.

When the user, for example, clicks on the I like this icon 407 in the GLUE toolbar 401 of FIG. 4A while viewing an object, the object is marked as being liked by the user. As a result, when the user or another viewer applies a mouse over to the associated object icon in the user's profile 410 (or to the user's icon in the GLUE toolbar 401), a details balloon 431 for the used includes an additional icon (“blue heart”) indicating that the object is liked by the user. The user may can remove this designation by again clicking on the I like this icon 407 in the toolbar 401 of FIG. 4A while viewing the object.

Similarly, by clicking on the Add my 2¢ icon 408 in the toolbar 401, a details balloon 521 appears as illustrated in FIG. 5F, which includes a comments box 522 soliciting the user's comments (“2cents”) regarding the object that the user is viewing (music object “None Too Soon”). The user may add comments to the comments box 523 as shown in FIG. 5G. Once added, comments may be further edited by the user. For example, as illustrated in FIG. 5H, by clicking on the object icon 402 for the music object “None Too Soon,” an object panel 524 appears. By selecting the summary button 525, a summary bar 526 appears above a summary window. By clicking on the “Edit my 2¢” icon 527, a details balloon 528 appears that enables the user to edit his or her “2cents.”

The toolbar 401 may at times include a “Tip” field 529, for example, as illustrated in FIG. 5I, to provide any of a number of suggestions to the user for improving his or her experience with the social network. As illustrated for example in FIG. 5I, a tip is provided for helping the user find other people to follow. By clicking on the tip field 529, a panel appears with action buttons 530 which provide links to a variety of social networking sources and other sources that the user can access to find additional friends to follow.

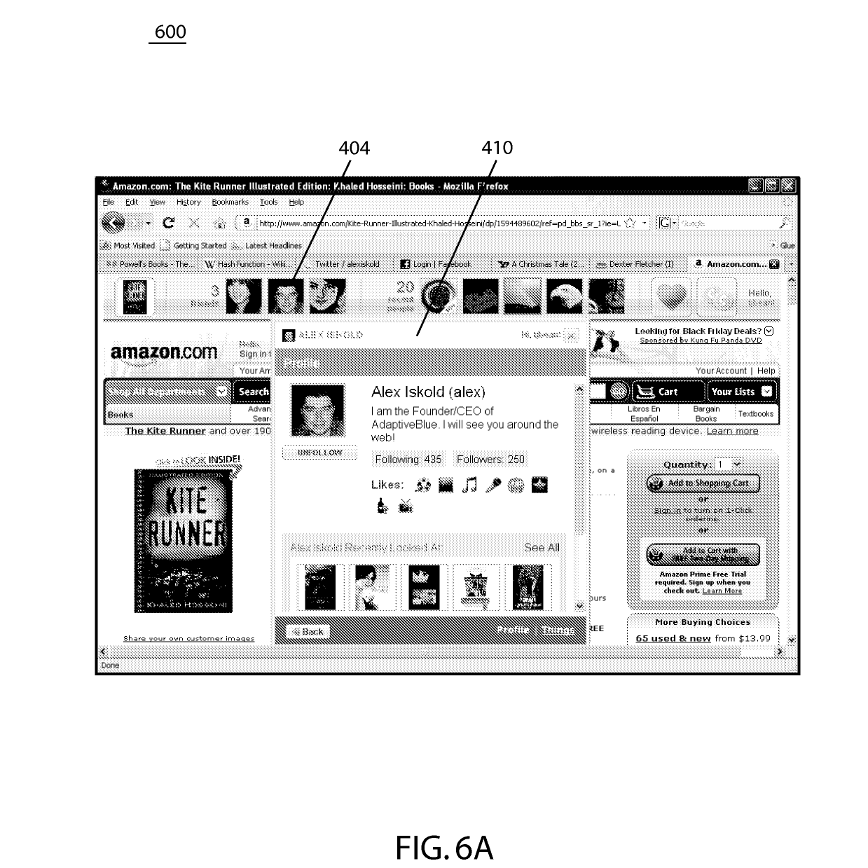

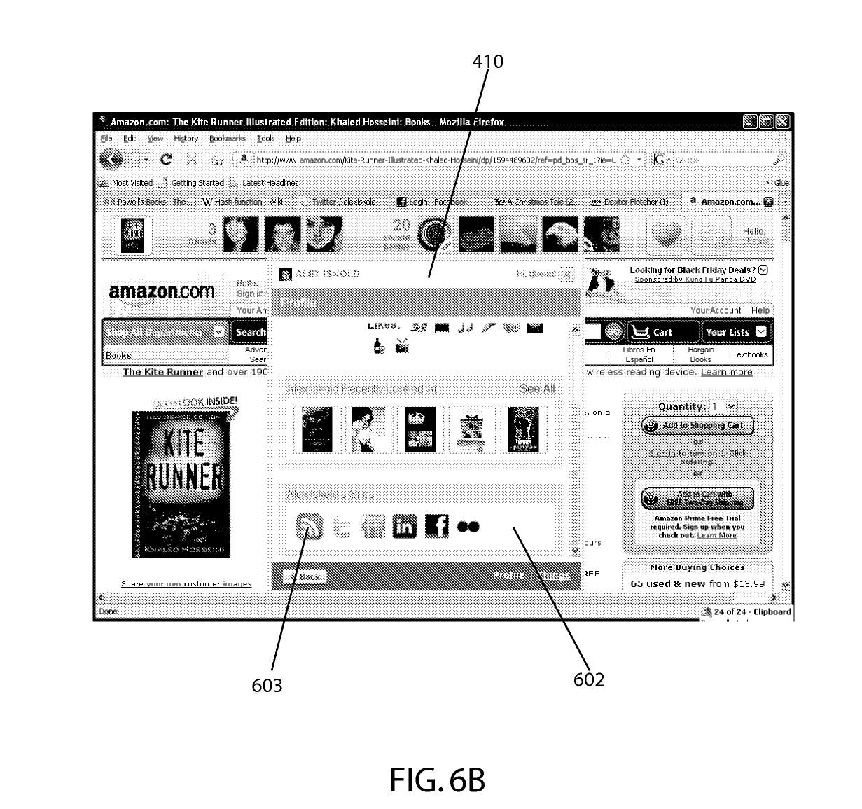

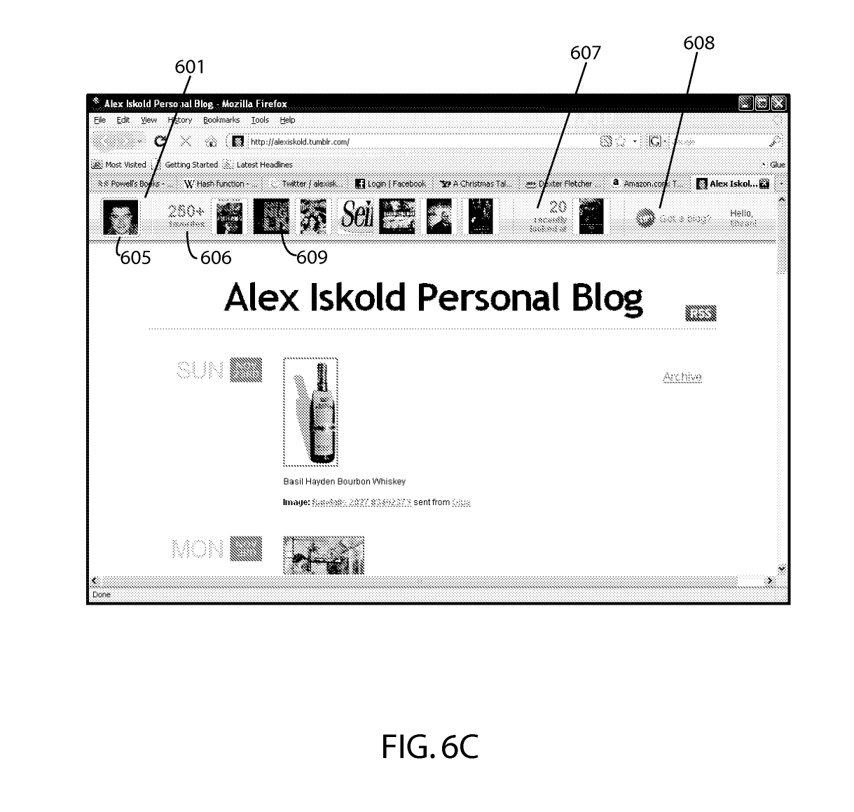

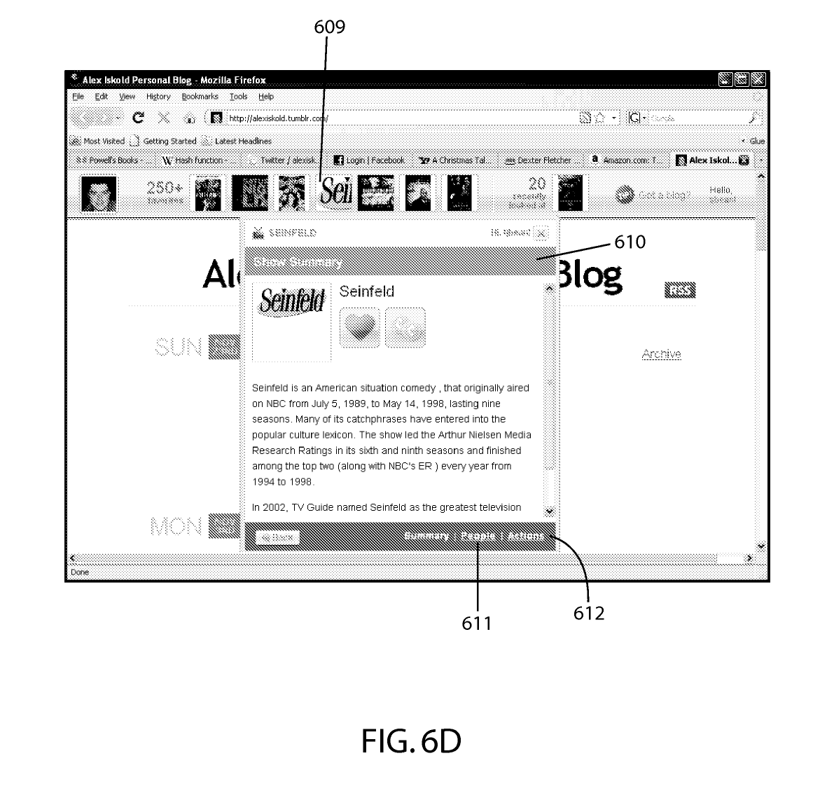

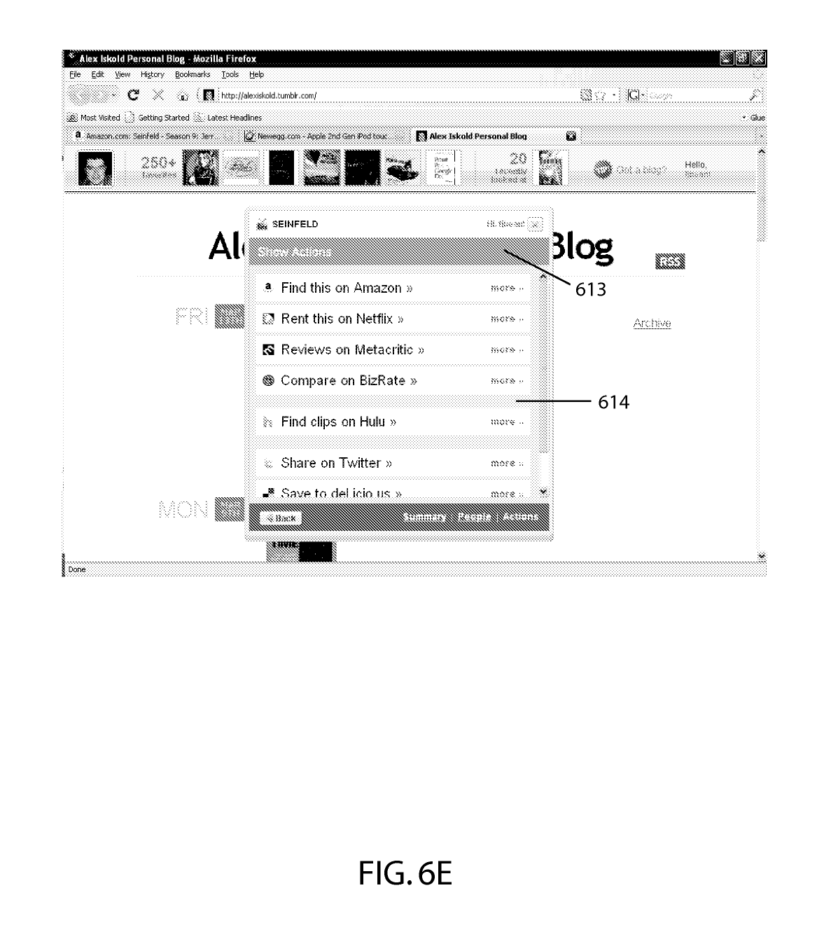

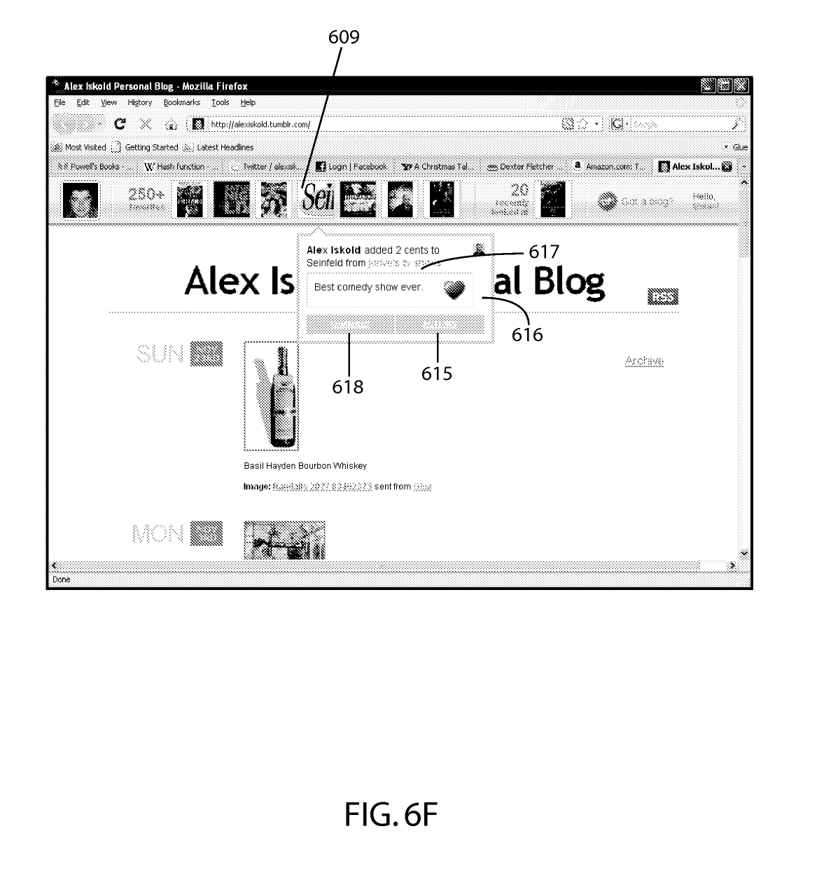

FIG. 6A illustrates a browser window 600 showing an AMAZON.COM web page having as its object the book “Kite Runner.” The user has clicked on a friend icon 404, and a profile 410 for the friend appears. As illustrated in FIG. 6B, by scrolling to the end of the profile 410, a “Friend's Sites” area 602 appears including site icons 603. By clicking on a site icon 603, for example, for the “TUMBLR.” blog site, the user is directed to a web page at the TUMBLR web site that hosts the friend's personal blog, as illustrated in FIG. 6C. A modified toolbar 601 appears, for example, at the top of the friend's personal blog page.

As illustrated in FIG. 6C, a friend icon 605 is provided in a leftmost region of the toolbar 601. Adjacent to the friend icon 605 is a “favorites” area 606, which indicates a number of favorite objects of the friend (i.e. objects that the friend designated as “liked”), and including favorites icons 609 representing at least a subset of the liked objects.

As illustrated for example in FIG. 6D, by clicking on one of the favorites icons 609, a pane appears that provides an object summary 610 for the favorite object. The object summary 610 preferably identifies an object type (Show”), and presents an object identifier (“Seinfeld”) together with an object icon and a textual description of the object (provided, for example, from a predetermined source such as an associated web page provided by a pre-identified web page provider). By clicking on a people link 611, a recent people/friends summary as previously described replaces the object summary 610 to provide information about recent people and friends who have viewed the object. By clicking on an “Actions” link 612 as shown in FIG. 6D, an actions summary 613 as illustrated in FIG. 6E replaces the object summary 610, presenting actions 614 which are selected for presentation in the actions summary 613 as being relevant to objects of the present object type (“Show”).

As illustrated for example in FIG. FF, by performing a mouse over over the favorite object icon 609 on the toolbar 601, a details balloon 616 appears which preferably identifies the friend, provides a link 617 to the web page or other site at which the friend viewed the favorite object (“jdrive's tv shows”), indicates that the object is a favorite object (for example, by presenting the “blue heart” icon) and provides comments in cases where the friend has added his or her “2cents.” The details balloon 516 also preferably includes a summary button 518 which can be clicked to cause the object summary 610 to appear, and the actions button 615 which can be clicked to cause the actions summary 613 to appear.

Returning to FIG. 6C, the modified toolbar 601 further includes a “Recently Looked At” area 507 adjacent to the favorites area 506. Preferably, the features of recently looked at area 607 essentially mirror the features of favorites area 606. Adjacent to recently looked at area 607, a tip field 608 may also be preferably provided on a continuing or periodic basis as described above. In the example illustrated in FIG. 6C, the tip provides a link for enabling the user to sign up as a participant on a blog site (for example, FACEBOOK).

Those skilled in the art will readily recognize numerous adaptations and modifications which can be made to the present invention which fall within the spirit and scope of the present invention as defined in the claims. Moreover, it is intended that the scope of the present invention include all foreseeable equivalents to the elements and structures as described with reference to FIGS. 1-6E. Accordingly, the invention is to be limited only by the scope of the claims and their equivalents.

We claim:

1. A method implemented on a server for dynamically constructing a social network in the context of objects viewed by users browsing the Internet, the method comprising the steps of:
receiving an object identifier for a first object viewed by a first user in a first browser window;
receiving a user identifier for the first user;
storing the user identifier at a first node for the first object;
storing the object identifier for the first object at a second node for the first user;
receiving an object identifier for the first object viewed by a second user in a second browser window;
receiving a user identifier for the second user;
determining that information about the first object is stored at the first node;
retrieving the user identifier for the first user from the first node; and
preparing information about the first user for display in the second browser window.

2. The method of claim 1, further comprising the step of:
storing the object identifier for the first object at a third node for the second user.

3. A method implemented on a computer for dynamically constructing a social network in the context of objects viewed by users browsing the Internet, the method comprising the steps of:
detecting a first object on a first web page viewed by a first user in a first browser window;
retrieving identification information for the first object from the first web page;
preparing an object identifier for the first object based on the identification information;
preparing a user identifier for the first user;
transmitting information over a computer network including the object identifier for the first object and the user identifier for the first user to at least a first node for the first object;
receiving information from the first node over the computer network identifying at least a second user who has viewed the first object at a second web page in a second browser window; and
displaying the information identifying the at least second user in the first browser window.

4. The method of claim 3, wherein the identification information for the first object is retrieved from meta data for the first web page.

5. The method of claim 3, wherein the step of retrieving identification information for the first object further comprises the steps of:
retrieving a uniform resource locator (URL) of the first web page;
performing a look-up operation for finding the URL in a URL cache, wherein the URL cache includes records mapping URLs to identification information for associated objects; and
retrieving identification information for the first object when the URL of the first web page is found in the URL cache.

6. The method of claim 3, wherein the step of retrieving identification information for the first object further comprises the steps of:
inferring an object type of the first object from code of the first web page; and
applying one or more agents to search for identification information in the code of the first web page, wherein each one of one or more agents searches for one of one or more predetermined object attributes for an object of the inferred object type.

7. The method of claim 3, further comprising the steps of:
receiving profile information for the second user over the computer network, said profile information for the second user including information about other objects viewed by the second user; and
displaying the profile information for the second user in the first browser window.

8. The method of claim 7, wherein the information about other objects viewed by the first user includes at least one of information about other objects recently viewed by the second user, information about other objects liked by the second user, or information about other objects commented on by the second user.

9. The method of claim 7, wherein the profile information farther includes information identifying other users who are linked to the second user.

10. The method of claim 9, wherein the other users who are linked to the first user include at least one of other users that the designated user has designated for following or other users who have designated the second user for following.

11. The method of claim 7, wherein the profile information further includes information about web pages having content provided by the second user.

12. The method of claim 3, further comprising the steps of:
receiving object information for the first object over the computer network, said retrieved object information including at least one of identification information for other users that have viewed the first object and have been designated for following by the second user or identification information for other users who have recently viewed the first object; and
displaying the object information for the first object in the first browser window.

13. The method of claim 12, further comprising the steps of:
preparing action links based on the identification information for the first object to other web pages, said action links being configured to initiate actions relating to the first object at the other web pages; and
displaying the action links in the second browser window.

14. A computer program product comprising one or more computer-readable storage media having stored computer-executable instructions to be executed by one or more computers, for implementing a method for dynamically constructing a social network in the context of objects viewed by users browsing the Internet, the instructions being arranged for performing the steps of:
detecting a first object on a first web page viewed by a first user in a first browser window;
retrieving identification information for the first object from the first web page;
preparing an object identifier for the first object based on the identification information;
determining a user identifier for the first user;
storing the user identifier at a first node for the first object;
storing the object identifier of the first object at a second node for the first user;
detecting the first object on a second web page viewed by a second user in a second browser window;
retrieving the object identifier for the first object from the second web page;
determining that information about the first object is stored at the first node;
retrieving the user identifier for the first user from the first node; and displaying information identifying the first user in the second browser window.

15. A method implemented on one or more computers for dynamically constructing a social network in the context of objects viewed by users browsing the Internet, the method comprising the steps of:
a) detecting an object on a web page viewed by a user in a browser window;
b) displaying information identifying a plurality of other users who have viewed the object, the displayed information being displayed together with the web page in the browser window;
c) detecting a selection operation by the user of one of the plurality of other users;
d) displaying information of the selected other user in the browser window, the information of the selected other user identifying a plurality of other objects previously viewed by the selected other user and a another plurality of other users each affiliated with the second user;
e) detecting a selection operation by the user of one of the plurality of other objects or one of the other plurality of other users; and
f) displaying information about the selected other object or the other selected other user in the browser window.

16. The method of claim 15, wherein the selected other object or other selected other user is another object, and the displayed information is another web page presenting the other object.

17. The method of claim 16, further comprising the steps of:
g) detecting the other object on the other web page; and
h) repeating steps b)-f) with reference to the other object.

18. The method of claim 15, wherein the selected other object or other selected other user is a second other user.

19. The method of claim 18, further comprising the step of:
h) repeating steps d)-f) with reference to the second other user.
